(19) United States
(12) Patent Application Publication
(10) Pub. No.: US 2026/0303448 A1
(43) Pub. Date: Oct. 1, 2026

(54) METHOD AND APPARATUS FOR CONFIGURING ARTIFICIAL INTELLIGENCE AND MACHINE LEARNING FUNCTIONALITIES IN A WIRELESS COMMUNICATION SYSTEM

(71) Applicant: ASUS Technology Licensing Inc., Taipei City (TW)

(72) Inventors: Cheng-Hsiu Chen, Taipei City (TW); Chun-Wei Huang, Taipei City (TW); Li-Chih Tseng, Taipei City (TW); Meng-Hui Ou, Taipei City (TW)

(21) Appl. No.: 19/578,704

(22) Filed: Mar. 25, 2026

Related U.S. Application Data
(60) Provisional application No. 63/777,350, filed on Mar. 25, 2025.

(51) Int. Cl. H04L 41/0803; H04L 5/00; H04W 24/08

(52) U.S. Cl. CPC H04L 41/0803; H04L 5/0048; H04W 24/08

(57) ABSTRACT

Methods, systems, and apparatuses are provided for configuring artificial intelligence and machine learning functionalities in a wireless communication system, wherein a method of a User Equipment (UE) comprises sending a first message to a Network (NW) comprising at least one of a first information or a second information based on whether or not the UE is configured with one or more first configurations, wherein: (i) if the UE is not configured with the one or more first configurations, the first message comprises the first information, wherein the first information comprises a request indicating a preference for receiving one or more data collection configurations, and (ii) if the UE is configured with the one or more first configurations, the first message comprises the second information, wherein the second information comprises one or more indications of one or more preferred data collection configurations based on the one or more first configurations.

### CROSS-REFERENCE TO RELATED APPLICATIONS

The present application claims priority to and the benefit of U.S. Provisional Patent Application Ser. No. 63/777,350, filed Mar. 25, 2025, which is hereby fully incorporated herein by reference.

### FIELD

This disclosure generally relates to wireless communication networks and, more particularly, to a method and apparatus for configuring artificial intelligence and machine learning functionalities in a wireless communication system.

### BACKGROUND

With the rapid rise in demand for communication of large amounts of data to and from mobile communication devices, traditional mobile voice communication networks are evolving into networks that communicate with Internet Protocol (IP) data packets. Such IP data packet communication can provide users of mobile communication devices with voice over IP, multimedia, multicast and on-demand communication services.

An exemplary network structure is an Evolved Universal Terrestrial Radio Access Network (E-UTRAN). The E-UTRAN system can provide high data throughput in order to realize the above-noted voice over IP and multimedia services. A new radio technology for the next generation (e.g., 5G) is currently being discussed by the 3GPP standards organization. Accordingly, changes to the current body of 3GPP standard are currently being submitted and considered to evolve and finalize the 3GPP standard.

### SUMMARY

Methods, systems, and apparatuses are provided for configuring artificial intelligence and machine learning functionalities in a wireless communication system. The User Equipment (UE) may initiate requests for measurements for UE-side data collection, while the Network (NW) may prevent the UE from requesting radio resources not available at the NW, but still satisfying the needs of the UE.

In various embodiments, a method of a UE comprises sending a first message to an NW comprising at least one of a first information or a second information based on whether or not the UE is configured with one or more first configurations, wherein: (i) if the UE is not configured with the one or more first configurations, the first message comprises the first information, wherein the first information comprises a request indicating a preference for receiving one or more data collection configurations, and (ii) if the UE is configured with the one or more first configurations, the first message comprises the second information, wherein the second information comprises one or more indications of one or more preferred data collection configurations based on the one or more first configurations, in accordance with embodiments of the present invention.

In various embodiments, a method of a UE comprises sending a first message to an NW indicating a first information, wherein the first information comprises a request indicating a preference for receiving one or more data collection configurations, receiving one or more first configurations from the NW, and sending a second message to the NW indicating a second information, wherein the second information comprises one or more indications of one or more preferred data collection configurations based on the one or more first configurations, in response to the UE receiving the one or more first configurations, in accordance with embodiments of the present invention.

### BRIEF DESCRIPTION OF THE DRAWINGS

FIG. 1 shows a diagram of a wireless communication system, in accordance with embodiments of the present invention.

FIG. 2 is a block diagram of a transmitter system (also known as access network) and a receiver system (also known as user equipment or UE), in accordance with embodiments of the present invention.

FIG. 3 is a functional block diagram of a communication system, in accordance with embodiments of the present invention.

FIG. 4 is a functional block diagram of the program code of FIG. 3, in accordance with embodiments of the present invention.

FIG. 5 is a reproduction of Figure 4.4-1: Functional framework for AI/ML for NR Air Interface, from 3GPP TR 38.843 V18.0.0 (2023-12) 3GPP.

FIG. 6 is a reproduction of Figure 7.2.1.1-1: Network decision, network-initiated AI/ML management, from 3GPP TR 38.843 V18.0.0 (2023-12) 3GPP.

FIG. 7 is a reproduction of Figure 7.2.1.1-2: Network decision, UE-initiated AI/ML management, from 3GPP TR 38.843 V18.0.0 (2023-12) 3GPP.

FIG. 8 is a reproduction of Figure 7.2.1.1-3: UE decision, event-triggered as configured by the network, from 3GPP TR 38.843 V18.0.0 (2023-12) 3GPP.

FIG. 9 is a reproduction of Figure 7.2.1.1-4: UE autonomous, decision reported to the network, from 3GPP TR 38.843 V18.0.0 (2023-12) 3GPP.

FIG. 10 is a reproduction of Figure 5.7.4.1-1: UE Assistance Information, from 3GPP TS 38.331 V18.3.0 (2024-09) 3GPP.

FIG. 11 is a diagram showing an example for requesting data collection and indicating UE preference, in accordance with embodiments of the present invention.

FIG. 12 is a flow diagram of a method of a UE in a wireless communication system comprising providing a first request to an NW, and receiving a first configuration from the NW, in accordance with embodiments of the present invention.

FIG. 13 is a flow diagram of a method of a UE in a wireless communication system comprising providing a first request to an NW, and receiving a first configuration from the NW, in accordance with embodiments of the present invention.

FIG. 14 is a flow diagram of a method of a UE in a wireless communication system comprising providing a first request to an NW, and receiving a first signaling from the NW, in accordance with embodiments of the present invention.

FIG. 15 is a flow diagram of a method of a UE in a wireless communication system comprising sending a first message to an NW comprising at least one of a first information or a second information based on whether or not the UE is configured with one or more first configurations, in accordance with embodiments of the present invention.

FIG. 16 is a flow diagram of a method of a UE in a wireless communication system comprising sending a first message to an NW indicating a first information, and receiving one or more first configurations from the NW, and sending a second message to the NW indicating a second information, in accordance with embodiments of the present invention.

### DETAILED DESCRIPTION

The invention described herein can be applied to or implemented in exemplary wireless communication systems and devices described below. In addition, the invention is described mainly in the context of the 3GPP architecture reference model. However, it is understood that with the disclosed information, one skilled in the art could easily adapt for use and implement aspects of the invention in a 3GPP2 network architecture as well as in other network architectures.

The exemplary wireless communication systems and devices described below employ a wireless communication system, supporting a broadcast service. Wireless communication systems are widely deployed to provide various types of communication such as voice, data, and so on. These systems may be based on code division multiple access (CDMA), time division multiple access (TDMA), orthogonal frequency division multiple access (OFDMA), 3GPP LTE (Long Term Evolution) wireless access, 3GPP LTE-A (Long Term Evolution Advanced) wireless access, 3GPP2 UMB (Ultra Mobile Broadband), WIMAX®, 3GPP NR (New Radio), or some other modulation techniques.

In particular, the exemplary wireless communication systems and devices described below may be designed to support one or more standards such as the standard offered by a consortium named “3rd Generation Partnership Project” referred to herein as 3GPP, including: [1] RP-240774, “Revised WID for NR_AIML_air”; [2] 3GPP TR 38.843 V18.0.0 (2023-12) 3GPP; TSG RAN; Study on Artificial Intelligence (AI)/Machine Learning (ML) for NR air interface (Release 18); [3] 3GPP TS 38.331 V18.3.0 (2024-09) 3GPP; TSG RAN; NR; Radio Resource Control (RRC) protocol specification (Release 18); and [4] RAN2 #128 ChairNotes. The standards and documents listed above are hereby expressly and fully incorporated herein by reference in their entirety.

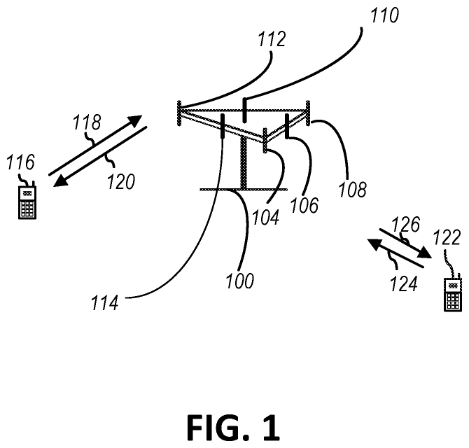

FIG. 1 shows a multiple access wireless communication system according to one embodiment of the invention. An access network 100 (AN) includes multiple antenna groups, one including 104 and 106, another including 108 and 110, and an additional including 112 and 114. In FIG. 1, only two antennas are shown for each antenna group, however, more or fewer antennas may be utilized for each antenna group. Access terminal (AT) 116 is in communication with antennas 112 and 114, where antennas 112 and 114 transmit information to access terminal 116 over forward link 120 and receive information from AT 116 over reverse link 118. AT 122 is in communication with antennas 106 and 108, where antennas 106 and 108 transmit information to AT 122 over forward link 126 and receive information from AT 122 over reverse link 124. In a FDD system, communication links 118, 120, 124 and 126 may use different frequency for communication. For example, forward link 120 may use a different frequency than that used by reverse link 118.

Each group of antennas and/or the area in which they are designed to communicate is often referred to as a sector of the access network. In the embodiment, antenna groups each are designed to communicate to access terminals in a sector of the areas covered by access network 100.

In communication over forward links 120 and 126, the transmitting antennas of access network 100 may utilize beamforming in order to improve the signal-to-noise ratio of forward links for the different access terminals 116 and 122. Also, an access network using beamforming to transmit to access terminals scattered randomly through its coverage normally causes less interference to access terminals in neighboring cells than an access network transmitting through a single antenna to all its access terminals.

The AN may be a fixed station or base station used for communicating with the terminals and may also be referred to as an access point, a Node B, a base station, an enhanced base station, an eNodeB, or some other terminology. The AT may also be called User Equipment (UE), a wireless communication device, terminal, access terminal or some other terminology.

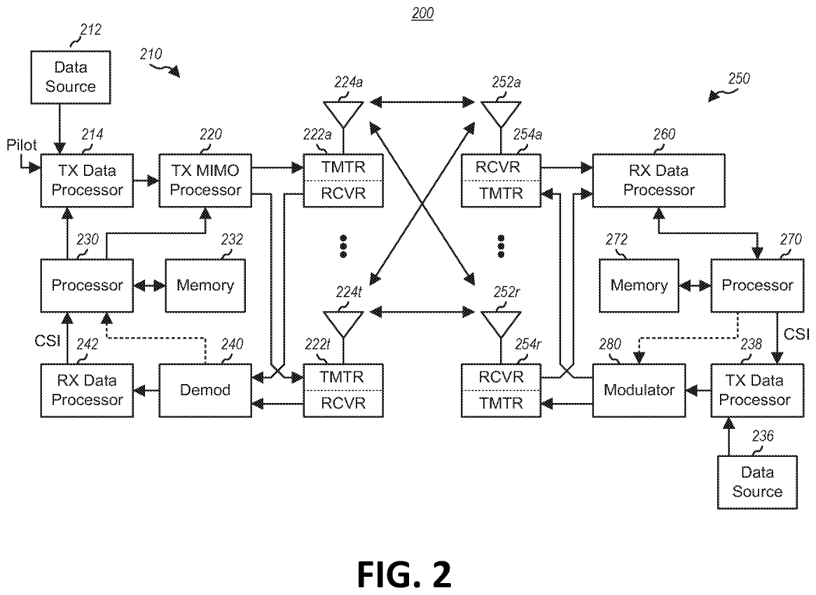

FIG. 2 is a simplified block diagram of an embodiment of a transmitter system 210 (also known as the access network) and a receiver system 250 (also known as access terminal (AT) or user equipment (UE)) in a MIMO system 200. At the transmitter system 210, traffic data for a number of data streams is provided from a data source 212 to a transmit (TX) data processor 214.

In one embodiment, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (e.g., symbol mapped) based on a particular modulation scheme (e.g., BPSK, QPSK, M-PSK, or M-QAM) selected for that data stream to provide modulation symbols. The data rate, coding, and modulation for each data stream may be determined by instructions performed by processor 230. A memory 232 is coupled to processor 230.

The modulation symbols for all data streams are then provided to a TX MIMO processor 220, which may further process the modulation symbols (e.g., for OFDM). TX MIMO processor 220 then provides NT modulation symbol streams to Nr transmitters (TMTR) 222a through 222t. In certain embodiments, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. Nr modulated signals from transmitters 222a through 222t are then transmitted from Nr antennas 224a through 224t, respectively.

At receiver system 250, the transmitted modulated signals are received by NR antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the N_{R} received symbol streams from N_{R} receivers 254 based on a particular receiver processing technique to provide N_{T} “detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use (discussed below). Processor 270 formulates a reverse link message comprising a matrix index portion and a rank value portion.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights then processes the extracted message.

Memory 232 may be used to temporarily store some buffered/computational data from 240 or 242 through Processor 230, store some buffed data from 212, or store some specific program codes. And Memory 272 may be used to temporarily store some buffered/computational data from 260 through Processor 270, store some buffed data from 236, or store some specific program codes.

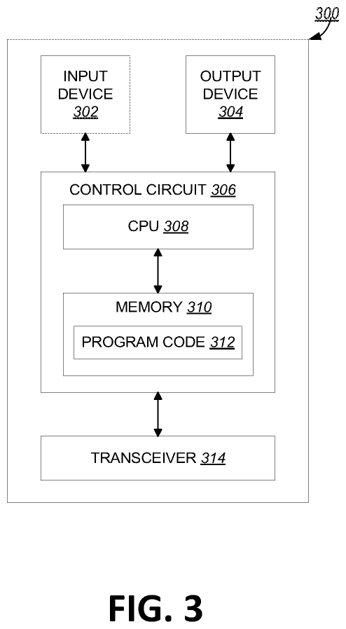

Turning to FIG. 3, this figure shows an alternative simplified functional block diagram of a communication device according to one embodiment of the invention. As shown in FIG. 3, the communication device 300 in a wireless communication system can be utilized for realizing the UEs (or ATs) 116 and 122 in FIG. 1, and the wireless communications system is preferably the NR system. The communication device 300 may include an input device 302, an output device 304, a control circuit 306, a central processing unit (CPU) 308, a memory 310, a program code 312, and a transceiver 314. The control circuit 306 executes the program code 312 in the memory 310 through the CPU 308, thereby controlling an operation of the communications device 300. The communications device 300 can receive signals input by a user through the input device 302, such as a keyboard or keypad, and can output images and sounds through the output device 304, such as a monitor or speakers. The transceiver 314 is used to receive and transmit wireless signals, delivering received signals to the control circuit 306, and outputting signals generated by the control circuit 306 wirelessly.

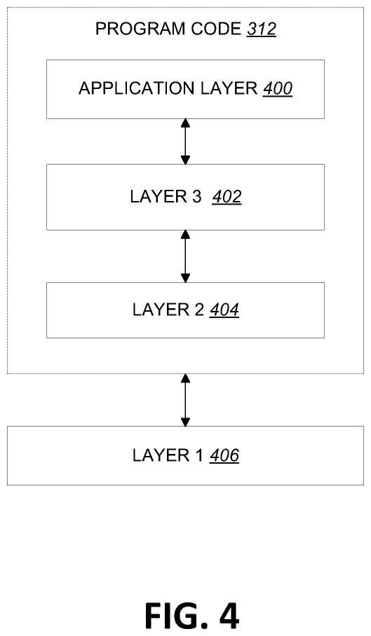

FIG. 4 is a simplified block diagram of the program code 312 shown in FIG. 3 in accordance with an embodiment of the invention. In this embodiment, the program code 312 includes an application layer 400, a Layer 3 portion 402, and a Layer 2 portion 404, and is coupled to a Layer 1 portion 406. The Layer 3 portion 402 generally performs radio resource control. The Layer 2 portion 404 generally performs link control. The Layer 1 portion 406 generally performs physical connections.

For LTE, LTE-A, or NR systems, the Layer 2 portion 404 may include a Radio Link Control (RLC) layer and a Medium Access Control (MAC) layer. The Layer 3 portion 402 may include a Radio Resource Control (RRC) layer.

Any two or more than two of the following paragraphs, (sub-) bullets, points, actions, or claims described in each invention paragraph or section may be combined logically, reasonably, and properly to form a specific method.

Any sentence, paragraph, (sub-) bullet, point, action, or claim described in each of the following invention paragraphs or sections may be implemented independently and separately to form a specific method or apparatus. Dependency, e.g., “based on”, “more specifically”, “example”, etc., in the following invention disclosure is just one possible embodiment which would not restrict the specific method or apparatus.

In WID RP-240774 ([1] RP-240774, “Revised WID for NR_AIML_air”) for AI/ML air interface, the following is provided:

### ******************************START OF QUOTATION [1]******************************

### 4.1 Objective of SI or Core Part WI or Testing Part WI

Provide specification support for the following aspects:
AI/ML general framework for one-sided AI/ML models within the realm of what has been studied in the FS_NR_AIML_Air project [RAN2]:
   Signalling and protocol aspects of Life Cycle Management (LCM) enabling functionality and model (if justified) selection, activation, deactivation, switching, fallback
      Identification related signalling is part of the above objective
   Necessary signalling/mechanism(s) for LCM to facilitate model training, inference, performance monitoring, data collection (except for the purpose of CN/OAM/OTT collection of UE-sided model training data) for both UE-sided and NW-sided models
   Signalling mechanism of applicable functionalities/models
Beam management-DL Tx beam prediction for both UE-sided model and NW-sided model, encompassing [RAN1/RAN2]:
   Spatial-domain DL Tx beam prediction for Set A of beams based on measurement results of Set B of beams (“BM-Case1”)
   Temporal DL Tx beam prediction for Set A of beams based on the historic measurement results of Set B of beams (“BM-Case2”)
   Specify necessary signalling/mechanism(s) to facilitate LCM operations specific to the Beam Management use cases, if any
   Enabling method(s) to ensure consistency between training and inference regarding NW-side additional conditions (if identified) for inference at UE
   NOTE: Strive for common framework design to support both BM-Case1 and BM-Case2
      . . .
      Study objectives with corresponding checkpoints in RAN #105 (Sept '24):
CSI feedback enhancement [RAN1]:
   For CSI compression (two-sided model), further study ways to:
      Improve trade-off between performance and complexity/overhead
         e.g., considering extending the spatial/frequency compression to spatial/temporal/frequency compression, cell/site specific models, CSI compression plus prediction (compared to Rel-18 non-AI/ML based approach), etc.
      Alleviate/resolve issues related to inter-vendor training collaboration.
   while addressing other aspects requiring further study/conclusion as captured in the conclusions section of the TR 38.843.
   For CSI prediction (UE-sided model), further study performance gain over Rel-18 non-AI/ML based approach and associated complexity, while addressing other aspects requiring further study/conclusion as captured in the conclusions section of the TR 38.843 (e.g., cell/site specific model could be considered to improve performance gain).
Necessity and details of model Identification concept and procedure in the context of LCM [RAN2/RAN1]
CN/OAM/OTT collection of UE-sided model training data [RAN2/RAN1]:
   For the FS_NR_AIML_Air study use cases, identify the corresponding contents of UE data collection
   Analyse the UE data collection mechanisms identified during the FS_NR_AIML_Air (TR 38.843 section 7.2.1.3.2) study along with the implications and limitations of each of the methods
Model transfer/delivery [RAN2/RAN1]:
   Determine whether there is a need to consider standardised solutions for transferring/delivering AI/ML model(s) considering at least the solutions identified during the FS_NR_AIML_Air study

### ******************************END OF QUOTATION [1]******************************

In TR 38.843 ([2] 3GPP TR 38.843 V18.0.0 (2023-12) 3GPP; TSG RAN; Study on Artificial Intelligence (AI)/Machine Learning (ML) for NR air interface (Release 18)), the following is provided:

### ******************************START OF QUOTATION [2]******************************

4 General AI/ML framework
The purpose of this clause is to identify common notation and terminology for AI/ML related functions, procedures and interfaces.
Note: The work done for FS_NR_ENDC_data_collect is considered when appropriate.

### 4.1 Description of AI/ML Stages

In this clause, the defining stages of AI/ML related algorithms and associated complexity are characterized, namely:
Model generation, e.g., model training (including input/output, pre-/post-process, online/offline as applicable), model validation, model testing, as applicable
Inference operation, e.g., input/output, pre-/post-process, as applicable
   In addition, the treatment of dataset(s) for training, validation, testing, and inference is documented.

### 4.2 Life Cycle Management

In this clause, the life cycle management (LCM) of AI/ML model (e.g., model training, model deployment, model inference, model monitoring, model updating) and AI/ML functionality are characterized.
The following aspects, including the definition of components (if needed) and necessity, are studied in LCM:
Data collection
   Note: This also includes associated assistance information, if applicable.
Model training
Functionality/model identification
Model delivery/transfer
Model inference operation
Functionality/model selection, activation, deactivation, switching, and fallback operation.
   Including: Decision by the network (either network initiated or UE-initiated and requested to the network), decision by the UE (event-triggered as configured by the network, UE's decision reported to the network, or UE-autonomous either with UE's decision reported to the network or without it)
Functionality/model monitoring
Model update
   UE capability
Note: Some aspects in the list may not have specification impact.

### 4.2.1 LCM Flavours

The LCM procedure is studied for the case that an AI/ML model has a model ID with associated information and/or for the case that a given functionality is provided by some AI/ML operations. Note: Applicability of functionality-based LCM and model-ID-based LCM is a separate discussion.
From RAN1 perspective, an AI/ML model identified by a model ID may be logical, and how it maps to physical AI/ML model(s) may be up to implementation. When distinction is necessary for discussion purposes, companies may use the term a logical AI/ML model to refer to a model that is identified and assigned a model ID, and physical AI/ML model(s) to refer to an actual implementation of such a model.
For UE-side models and UE-part of two-sided models:
For AI/ML functionality identification
   Legacy 3GPP framework of feature is taken as a starting point.
   UE indicates supported functionalities/functionality for a given sub-use-case.
      UE capability reporting is taken as starting point.
   For AI/ML model identification
      Models are identified by model ID at the Network. UE indicates supported AI/ML models.
         In functionality-based LCM, network indicates activation/deactivation/fallback/switching of AI/ML functionality via 3GPP signalling (e.g., RRC, MAC-CE, DCI). Models may not be identified at the Network, and UE may perform model-level LCM. Whether and how much awareness/interaction NW should have about model-level LCM requires further study. For functionality identification, there may be either one or more than one Functionalities defined within an AI/ML-enabled feature, whereby AI/ML-enabled Feature refers to a Feature where AI/ML may be used. Note: UE may have one AI/ML model for the functionality, or UE may have multiple AI/ML models for the functionality.
         For AI/ML functionality identification and functionality-based LCM of UE-side models and/or UE-part of two-sided models, functionality refers to an AI/ML-enabled Feature/FG enabled by configuration(s), where configuration(s) is (are) supported based on conditions indicated by UE capability. Correspondingly, functionality-based LCM operates based on, at least, one configuration of AI/ML-enabled Feature/FG or specific configurations of an AI/ML-enabled Feature/FG.
         After functionality identification, necessity, mechanisms, for UE to report updates on applicable functionality(es) among functionality(es) are studied, where the applicable functionalities may be a subset of all functionalities. Applicable functionalities can be reported by the UE.
         In model-ID-based LCM, models are identified at the Network, and Network/UE may activate/deactivate/select/switch individual AI/ML models via model ID.
         For AI/ML model identification and model-ID-based LCM of UE-side models and/or UE-part of two-sided models, model-ID-based LCM operates based on identified models, where a model may be associated with specific configurations/conditions associated with UE capability of an AI/ML-enabled Feature/FG and additional conditions (e.g., scenarios, sites, and datasets) as determined/identified between UE-side and NW-side.
         After model identification, necessity, mechanisms, for UE to report updates on applicable UE part/UE-side model(s), are studied, where the applicable models may be a subset of all identified models. Applicable models can be reported by the UE.
         How to handle the impact of UE's internal conditions such as memory, battery, and other hardware limitations on functionality/model operations and AI/ML-enabled Feature is to be studied. Note: it does not preclude any existing solutions.
         For functionality/model-ID based LCM, once functionalities/models are identified, the same or similar procedures may be used for their activation, deactivation, switching, fallback, and monitoring.
         Model ID, if needed, can be used in a Functionality (defined in functionality-based LCM) for LCM operations.

### 4.2.2 Model Identification

For AI/ML model identification of UE-side or UE-part of two-sided models, model identification is categorized in the following types:
Type A: Model is identified to NW (if applicable) and UE (if applicable) without over-the-air signalling
   The model may be assigned with a model ID during the model identification, which may be referred/used in over-the-air signalling after model identification.
Type B: Model is identified via over-the-air signalling,
   Type B1:
      Model identification initiated by the UE, and NW assists the remaining steps (if any) of the model identification
         the model may be assigned with a model ID during the model identification
   Type B2:
      Model identification initiated by the NW, and UE responds (if applicable) for the remaining steps (if any) of the model identification
         the model may be assigned with a model ID during the model identification
Note: This study does not imply that model identification is necessary.
   One example use case for Type B1 and B2 is model identification in model transfer from NW to UE. Another example is model identification with data collection related configuration(s) and/or indication(s) and/or dataset transfer. Note: Other example use cases are not precluded. Note: Offline model identification may be applicable for some of the example use cases.
   Once models are identified, at least for Type A, UE can indicate supported AI/ML model IDs for a given AI/ML-enabled Feature/FG in a UE capability report as starting point. Note: model identification using capability report is not precluded for type B1 and type B2.
   Model ID may or may not be globally unique, and different types of model IDs may be created for a single model for various LCM purposes. Note: Details can be studied in the WI phase.

### 4.2.3 Additional Conditions

For an AI/ML-enabled feature/FG, additional conditions refer to any aspects that are assumed for the training of the model but are not a part of UE capability for the AI/ML-enabled feature/FG. It does not imply that additional conditions are necessarily specified. Additional conditions can be divided into two categories: NW-side additional conditions and UE-side additional conditions. Note: whether specification impact is needed is a separate discussion.
For inference for UE-side models, to ensure consistency between training and inference regarding NW-side additional conditions (if identified), the following options can be taken as potential approaches (when feasible and necessary):
Model identification to achieve alignment on the NW-side additional condition between NW-side and UE-side
Model training at NW and transfer to UE, where the model has been trained under the additional condition
Information and/or indication on NW-side additional conditions is provided to UE
Consistency assisted by monitoring (by UE and/or NW, the performance of UE-side candidate models/functionalities to select a model/functionality)
Other approaches are not precluded
Note: the possibility that different approaches can achieve the same function is not denied

### 4.2.4 Scenario/Configuration Specific Models

Scenario/configuration specific (including site-specific configuration/channel conditions) models may provide performance benefits in some studied use cases (i.e., when a single model cannot generalize well to multiple scenarios/configurations/sites).
At least, when UE has limitation to store all related models, model delivery/transfer, if feasible, to UE may be beneficial, at the cost of overhead/latency associated with model delivery/transfer.
Note: On-device Finetuning/retraining, if feasible, of a single model may be an alternative to model delivery/transfer.
Note: a single model may generalize well in some studied use cases.
Note: Model transfer/delivery to UE may also face challenges, e.g., proprietary issues/burdens in some scenarios
   Various approaches for achieving good performance across different scenarios/configurations/sites are studied, including
Model generalization, i.e., using one model that is generalizable to different scenarios/configurations/sites
Model switching, i.e., switching among a group of models where each model is for a particular scenario/configuration/site
   Models in a group of models may have varying model structures, share a common model structure, or partially share a common sub-structure. Models in a group of models may have different input/output format and/or different pre-/post-processing.
Model update, i.e., using one model whose parameters are flexibly updated as the scenario/configuration/site that the device experiences changes over time. Fine-tuning is one example.

### 4.2.5 Data Collection

Data collection may be performed for different purposes in LCM, e.g., model training, model inference, model monitoring, model selection, model update, etc. each may be done with different requirements and potential specification impact.
For all types of offline model training (i.e., UE-/NW-/two-sided model training), there is no latency requirement for data collection. For model inference, when required data comes from other entities, there is a latency requirement for data collection. For (real-time) performance monitoring, when required monitoring data (e.g., performance metric) comes from other entities, there is a latency requirement for data collection.
At least for the use cases studied in this study item, it is assumed that the analysis/selection of the data collection frameworks should focus on the RRC_CONNECTED state (for both data generation and reporting). Analysis and potential enhancement of the non-connected state can be revisited when needed. Note that existing specification supports DL PRS measurement and UE positioning in both RRC_CONNECTED and RRC_INACTIVE state.
At least the following aspects, if applicable, are considered along with the corresponding specification impact:
Measurement configuration and reporting
Contents, type and format of data including:
   Data related to model input
   Data related to ground-truth
   Quality of the data
   Other information
Signalling of assistance information for categorizing the data
   Note: The study should consider the feasibility of disclosure of proprietary information
Signalling for data collection procedure

### 4.4 Functional Framework Details

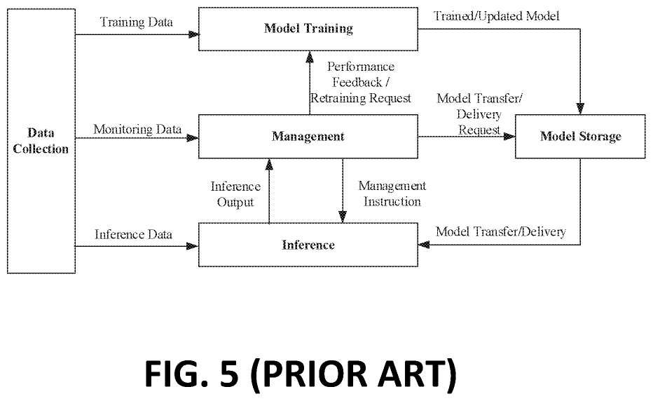

This section introduces the functional framework for AI/ML for NR air interface illustrated in Figure 4.4-1. The aim of this framework is to cover a general functional architecture addressing both model-ID-based LCM and functionality-based LCM, introduced in clause 4.2. Therefore, some of the functions or data/information/instruction flows (i.e., the arrows) shown in the Figure 4.4-1 might not always be relevant for a given LCM approach. As an illustrative example, consider a scenario where the network performs functionality-based LCM and where models are not identified in the network, while the UE concurrently performs model-level management (e.g., model selection/switching/(de) activation, etc.,). In this hypothetical case, the “Model Training” or “Model Storage” functions with their respective procedures, may be regarded as irrelevant from the network's perspective.
In clause 7, the functions and data/information/instruction flows (i.e., the arrows) depicted in Figure 4.4-1 are analysed for any standardization impact and its implications.
Note: The functional framework and high-level procedures defined in this TR should not prevent from “thinking beyond” them during a normative phase if any use case requires so.
FIG. 5 is a reproduction of Figure 4.4-1: Functional framework for AI/ML for NR Air Interface, from 3GPP TR 38.843 V18.0.0 (2023-12) 3GPP.
   As seen in Figure 4.4-1, the general framework consists of the following:
Data Collection is a function that provides input data to the Model Training, Management, and Inference functions.
   Training Data: Data needed as input for the AI/ML Model Training function.
   Monitoring Data: Data needed as input for the Management of AI/ML models or AI/ML functionalities.
   Inference Data: Data needed as input for the AI/ML Inference function.
Model Training is a function that performs AI/ML model training, validation, and testing which may generate model performance metrics which can be used as part of the model testing procedure. The Model Training function is also responsible for data preparation (e.g., data pre-processing and cleaning, formatting, and transformation) based on Training Data delivered by a Data Collection function, if required.
   Trained/Updated Model: In case of having a Model Storage function, this is used to deliver trained, validated, and tested AI/ML models to the Model Storage function, or to deliver an updated version of a model to the Model Storage function.
Management is a function that oversees the operation (e.g., selection/(de) activation/switching/fallback) and monitoring (e.g., performance) of AI/ML models or AI/ML functionalities. This function is also responsible for making decisions to ensure the proper inference operation based on data received from the Data Collection function and the Inference function.
   Management Instruction: Information needed as input to manage the Inference function. Concerning information may include selection/(de) activation/switching of AI/ML models or AI/ML-based functionalities, fallback to non-AI/ML operation (i.e., not relying on inference process), etc.,
   Model Transfer/Delivery Request: Used to request model(s) to the Model Storage function.
   Performance Feedback/Retraining Request: Information needed as input for the Model Training function, e.g., for model (re) training or updating purposes.
Inference is a function that provides outputs from the process of applying AI/ML models or AI/ML functionalities, using the data that is provided by the Data Collection function (i.e., Inference Data) as an input. The Inference function is also responsible for data preparation (e.g., data pre-processing and cleaning, formatting, and transformation) based on Inference Data delivered by a Data Collection function, if required.
   Inference Output: Data used by the Management function to monitor the performance of AI/ML models or AI/ML functionalities.
Model Storage is a function responsible for storing trained/updated models that can be used to perform the Inference function.
   Note: The Model Storage function in Figure 4.4-1 is only intended as a reference point (if any) when applicable for protocol terminations, model transfer/delivery, and related processes. It should be stressed that its purpose does not encompass restricting the actual storage locations of models. Therefore, the specification impact of all data/information/instruction flows (i.e., the arrows in Figure 4.4-1) to/from this function should be studied case by case.
   Model Transfer/Delivery: Used to deliver an AI/ML model to the Inference function.

### 5 Use Cases

Initial set of use cases includes:
CSI feedback enhancement, e.g., overhead reduction, improved accuracy, prediction [RAN1]
Beam management, e.g., beam prediction in time, and/or spatial domain for overhead and latency reduction, beam selection accuracy improvement [RAN1]
Positioning accuracy enhancements for different scenarios including, e.g., those with heavy NLOS conditions [RAN1]
The AI/ML approaches for the selected sub use cases need to be diverse enough to support various requirements on the gNB-UE collaboration levels
   Note: the selection of use cases for this study solely targets the formulation of a framework to apply AI/ML to the air-interface for these and other use cases. The selection itself does not intend to provide any indication of the prospects of any future normative project.

### 5.1 CSI Feedback Enhancement

### Finalization of Representative Sub-Use Cases:

The following are selected as representative sub-use cases:
Spatial-frequency domain CSI compression using two-sided AI model. Note: All pre-processing/post-processing, quantization/de-quantization are within the scope of the sub use case.
   The study of AI/ML based CSI compression should be based on the legacy CSI feedback signalling framework.
Time domain CSI prediction using UE-side model.
   For CSI compression using two-sided model use case, considered AI/ML model training collaborations include:
Type 1: Joint training of the two-sided model at a single side/entity, e.g., UE-sided or Network-sided.
Type 2: Joint training of the two-sided model at network side and UE side, respectively.
Type 3: Separate training at network side and UE side, where the UE-side CSI generation part and the NW-side CSI reconstruction part are trained by UE side and network side, respectively.
Note: Joint training means the generation model and reconstruction model should be trained in the same loop for forward propagation and backward propagation. Joint training could be done both at single node or across multiple nodes (e.g., through gradient exchange between nodes).
Note: Separate training includes sequential training starting with UE side training, or sequential training starting with NW side training
Note: training collaboration Type 2 over the air interface for model training (not including model update) is concluded to be deprioritized in Rel-18 SI.
   For Type 2 (Joint training of the two-sided model at network side and UE side, respectively), note that joint training includes both simultaneous training and sequential training, in which the pros and cons could be discussed separately. Further, note that Type 2 sequential training starts with NW side training.
   In CSI compression using two-sided model use case, for discussion of training collaboration Type 1, separate columns are shown for both known model structure, and unknown model structure separately for NW-sided and UE-sided, respectively. Table 5.1-1 captures the pros/cons of training collaboration Type 1 for CSI compression using two-sided model use case.

TABLE 5.1-1
Pros and Cons of training collaboration Type 1

| | Training Types | | | |
|---|---|---|---|---|
| | Type 1: NW side | | Type 1: UE side | |
| | Unknown | Known | Unknown | Known |
| | model | model | model | model |
| | structure | structure | structure | structure |
| Characteristics | at UE | at UE | at UE | at UE |
| Whether model can be kept | No | No | No | No |
| proprietary | | | | |
| Whether require privacy-sensitive | No (Note 1) | No (Note 1) | No (Note 1) | No (Note 1) |
| dataset sharing | | | | |
| Flexibility to support | Flexible | Flexible | Flexible | Flexible |
| cell/site/scenario/configuration specific | except for UE | except for UE | except for NW | except for NW |
| model | defined | defined | defined | defined |
| | scenarios. | scenarios. | scenarios. | scenarios. |
| | Not | Not | Not | Not |
| | flexible for UE | flexible for UE | flexible for NW | flexible for NW |
| | defined | defined | defined | defined |
| | scenarios | scenarios | scenarios | scenarios |
| | unless UE | unless UE | unless NW | unless NW |
| | assistance | assistance | assistance | assistance |
| | information is | information is | information is | information is |
| | supported and | supported and | supported and | supported and |
| | available. | available. | available. | available. |
| | (Note 6) | (Note 6) | (Note 6) | (Note 6) |
| Whether gNB/device specific | gNB: Yes | gNB: Yes | gNB: No | gNB: less |
| optimization is allowed | UE: No | UE: less | UE: Yes | flexible |
| | | flexible | | compared to |
| | | compared to | | NW side |
| | | UE side | | UE: Yes |
| Model update flexibility after | Flexible | Flexible | Flexible, | Flexible |
| deployment | only if UE | for parameter | less flexible | for parameter |
| | supports the | update | than Type 1 | update, less |
| | new structure | | NW side | flexible than |
| | | | | Type 1 NW |
| | | | | side |
| Feasibility of allowing UE side and | gNB: | gNB: | gNB: Not | gNB: Not |
| NW side to develop/update models | Feasible | Feasible with | feasible due to | feasible due to |
| separately | UE: Not | restriction for | Type 1 | Type 1 |
| | feasible due to | CSI | definition. | definition. |
| | Type 1 | reconstruction | UE: | UE: |
| | definition. | model. | Feasible. | Feasible with |
| | | UE: Not | | restriction for |
| | | feasible due to | | CSI |
| | | Type 1 | | generation |
| | | definition. | | model. |
| Whether gNB can maintain/store a | Yes | Yes. | No | No |
| single/unified CSI reconstruction | | Performance | | |
| model over different UEs (Note 2) | | refers to | | |
| | | observations | | |
| | | in “1 NW part | | |
| | | model to M > 1 | | |
| | | UE part | | |
| | | models” of | | |
| | | clause 6.2.2.4 | | |
| | | (Note 4) | | |
| Whether UE device can | No | No | Yes | Yes. |
| maintain/store a single/unified CSI | | | | Performance |
| generation model over different NW | | | | refers to |
| vendors (Note 3) | | | | observations |
| | | | | in “1 UE part |
| | | | | model to N > 1 |
| | | | | NW part |
| | | | | models” of |
| | | | | clause 6.2.2.4 |
| | | | | (Note 4) |
| Extendibility: to train new UE-side | Yes | Yes | No | No |
| model compatible with NW-side model | | | consensus | consensus |
| in use; (Note 5) | | | | |
| Extendibility: To train new NW-side | No | No | Yes | Yes |
| model compatible with UE-side model | consensus | consensus | | |
| in use; (Note 5) | | | | |
| Whether training data distribution can | Limited | Limited | Yes | Yes |
| match the inference device | | | | |
| Software/hardware compatibility | No for UE | Yes | No for | Yes |
| (Whether device capability can be | | | NW | |
| considered for model development) | | | | |
| Model performance | Performance | Performance | Performance | Performance |
| | refers to | refers to | refers to | refers to |
| | clause 6.2.2 | clause 6.2.2 | clause 6.2.2 | clause 6.2.2 |

(Note 1):
Assume precoding matrix is not privacy sensitive data. FFS: other information such as channel matrix and assisted information.
(Note 2):
Whether gNB/UE needs to maintain/store multiple CSI generation/reconstruction models respectively, is not discussed.
(Note 3):
For model inference, UE does not need to use multiple models from different NW vendors per cell.
(Note 4):
One to many joint trainings is assumed.
(Note 5):
The performance of the new model is similar to the performance of sequential training when training Type 1 support freezing a part of two sided model.
(Note 6):
For this table, NW defined scenarios are scenarios with NW defined dataset categorization. UE defined scenarios are scenarios with UE defined dataset categorization.

Table 5.1-2 captures the pros/cons of training collaboration Type 2 and Type 3 for CSI compression using two-sided model use case.

TABLE 5.1-2
Pros and Cons of training collaboration Type 2 and Type 3

| | Training Types | | | |
|---|---|---|---|---|
| | Type 2 | | Type 3 | |
| Characteristics | Simultaneous | Sequential | NW first | UE first |
| Whether model can be kept | Yes (Note 1) | Yes (Note 1) | Yes (Note 1) | Yes (Note 1) |
| proprietary | | | | |
| Whether requires privacy-sensitive | No (Note 2) | No (Note 2) | No (Note 2) | No (Note 2) |
| dataset sharing | | | | |
| Flexibility to support | No consensus | No consensus | [Semi] flexible | [Semi] flexible |
| cell/site/scenario/configuration | | | except for UE | except for NW |
| specific model | | | defined | defined |
| | | | scenarios. | scenarios |
| | | | (Note 3) | (Note 3). |
| | | | [Semi] flexible | [Semi] flexible |
| | | | for UE defined | for NW |
| | | | scenarios if | defined |
| | | | UE assistance | scenarios if |
| | | | information is | NW |
| | | | supported and | assistance |
| | | | available. | information is |
| | | | | supported and |
| | | | | available. |
| Whether gNB/device specific | Yes | Yes | Yes | Yes |
| optimization is allowed | | | | |
| Model update flexibility after | Not flexible | No consensus | Semi-flexible | Semi-flexible |
| deployment (Note 4) | | | | |
| Feasibility of allowing UE side and | Infeasible | No consensus | Feasible | Feasible |
| NW side to develop/update models | | | | |
| separately | | | | |
| Whether gNB can maintain/store a | Yes. | Yes. | Yes. | Yes. |
| single/unified model over different | Performance | Performance | Performance | Performance |
| UE vendors (Note 5) | refers to | refers to | refers to | refers to |
| | observations | observations | observations | observations |
| | in “1 NW part | in “1 NW part | in “NW first | in “UE first |
| | model to M > 1 | model to M > 1 | training, 1 NW | training, M > 1 |
| | UE part | UE part | part model to | UE part |
| | models” and | models” of | 1 UE part | models to 1 |
| | “1 UE part | clause 6.2.2.4. | model, same | NW part |
| | model to N > 1 | | backbone” | model” of |
| | NW part | | and “NW first | clause 6.2.2.5. |
| | models” of | | training, 1 NW | |
| | clause 6.2.2.4. | | part model to | |
| | | | 1 UE part | |
| | | | model, | |
| | | | different | |
| | | | backbones” of | |
| | | | clause 6.2.2.5. | |
| Whether UE device can | Yes. | Yes. | Yes. | Yes. |
| maintain/store a single/unified CSI | Performance | Performance | Performance | Performance |
| generation model over different NW | refers to | refers to | refers to | refers to |
| vendors (Note 6) | observations | observations | observations | observations |
| | in “1 NW part | in “1 NW part | in “NW first | in “UE first |
| | model to M > 1 | model to M > 1 | training, 1 UE | training, 1 NW |
| | UE part | UE part | part model to | part model to |
| | models” and | models” of | N > 1 NW part | 1 UE part |
| | “1 UE part | clause 6.2.2.4. | models” of | model, same |
| | model to N > 1 | | clause 6.2.2.5. | backbone”. |
| | NW part | | | And “UE first |
| | models” of | | | training, 1 NW |
| | clause 6.2.2.4. | | | part model to |
| | | | | 1 UE part |
| | | | | model, |
| | | | | different |
| | | | | backbones” of |
| | | | | clause 6.2.2.5. |
| Extendibility: to train new UE-side | Not support | Support | Support | No consensus |
| model compatible with NW-side model | | | | |
| in use; | | | | |
| Extendibility: To train new NW-side | Not support | Not support | No consensus | Support |
| model compatible with UE-side model | | | | |
| in use | | | | |
| Whether training data distribution can | No consensus | Yes for UE- | Limited | Yes |
| match the inference device | | part model, | | |
| | | limited for | | |
| | | NW-part | | |
| | | model | | |
| Software/hardware compatibility | Compatible | Compatible | Compatible | Compatible |
| (Whether device capability can be | | | | |
| considered for model development) | | | | |
| Model performance | Performance | Performance | Performance | Performance |
| | refers to | refers to | refers to | refers to |
| | clause 6.2.2 | clause 6.2.2 | clause 6.2.2 | clause 6.2.2 |

(Note 1):
Assume information on model structure disclosed in training collaboration does not reveal proprietary information.
(Note 2):
Assume precoding matrix is not privacy sensitive data. FFS: other information such as channel matrix and assisted information.
(Note 3):
For this table, NW defined scenarios are scenarios with NW defined dataset categorization. UE defined scenarios are scenarios with UE defined dataset categorization. [Semi] means no consensus for including “semi”.
(Note 4):
Flexibility after deployment is evaluated by the amount of offline cross-vendor co-engineering effort. Flexible indicates minimum additional co-engineering between vendors, semi-flexible indicates additional co-engineering effort between vendors.
(Note 5):
Whether gNB/UE needs to maintain/store multiple CSI generation/reconstruction models respectively, is not discussed.
(Note 6):
For model inference, UE does not need to use multiple models from different NW vendors per cell.

For CSI compression use case:
For model training, training data can be generated by UE/gNB
For NW-part of two-sided model inference, input data can be generated by UE and terminated at gNB.
For UE-part of two-sided model inference, input data is internally available at UE.
For performance monitoring at the NW side, calculated performance metrics (if needed) or data needed for performance metric calculation (if needed) can be generated by UE and terminated at gNB
   In CSI compression using two-sided model use case, in order to select a CSI generation model compatible with the CSI reconstruction model used by the gNB, the following aspect has been proposed:
Pairing information can be established based on model identification
   For CSI prediction use cases:
For model training, training data can be generated by UE.
For UE-side model inference, input data is internally available at UE.
For performance monitoring at the NW side, calculated performance metrics (if needed) or data needed for performance metric calculation (if needed) can be generated by UE and terminated at gNB.

### 5.2 Beam Management

### Finalization of Representative Sub-Use Cases:

The following are selected as representative sub-use cases:
BM-Case1: Spatial-domain Downlink beam prediction for Set A of beams based on measurement results of Set B of beams
   Consider: Alt. 1): AI/ML model training and inference at NW side. Alt. 2): AI/ML model training and inference at UE side.
   Consider: Alt. i): Set A and Set B are different (Set B is NOT a subset of Set A). Alt. ii): Set B is a subset of Set A. Note: Set A is for DL beam prediction. The codebook construction of Set A and Set B can be clarified by companies.
   AI/ML model input consider: Alt 1): Only L1-RSRP measurement based on Set B; Alt.2): L1-RSRP measurement based on Set B and assistance information; Alt. 3): CIR based on Set B; Alt. 4): L1-RSRP measurement based on Set B and the corresponding DL Tx and/or Rx beam ID.
BM-Case2: Temporal Downlink beam prediction for Set A of beams based on the historic measurement results of Set B of beams
   Consider: Alt. 1): AI/ML model training and inference at NW side. Alt. 2): AI/ML model training and inference at UE side.
   Consider: Alt. i): Set A and Set B are different (Set B is NOT a subset of Set A). Alt. ii): Set B is a subset of Set A (Set A and Set B are not the same). Alt. iii): Set A and Set B are the same.
   AI/ML model input consider: measurement results of K (K≥1) latest measurement instances with the following alternatives: Alt. 1): Only L1-RSRP measurement based on Set B; Alt 2): L1-RSRP measurement based on Set B and assistance information; Alt. 3): L1-RSRP measurement based on Set B and the corresponding DL Tx and/or Rx beam ID.
   F predictions for F future time instances can be obtained based on the output of AI/ML model, where each prediction is for each time instance. At least F=1.
      Set B is a set of beams whose measurements are taken as inputs of the AI/ML model.
Note: Beams in Set A and Set B can be in the same Frequency Range.
   For both sub-use cases, the following alternatives are studied for the predicted beams:
Alt.1: DL Tx beam prediction
Alt.2: DL Rx beam prediction (deprioritized)
Alt.3: Beam pair prediction (a beam pair consists of a DL Tx beam and a corresponding DL Rx beam)
Note: DL Rx beam prediction may or may not have spec impact.
   The following alternatives according to AI/ML model output are considered:
Alt.1: Tx and/or Rx Beam ID(s) and/or the predicted L1-RSRP of the N predicted DL Tx and/or Rx beams
   e.g., N predicted beams can be the Top-N predicted beams
Alt.2: Tx and/or Rx Beam ID(s) of the N predicted DL Tx and/or Rx beams and other information
   e.g., N predicted beams can be the Top-N predicted beams
Alt.3: Tx and/or Rx Beam angle(s) and/or the predicted L1-RSRP of the N predicted DL Tx and/or Rx beams
   e.g., N predicted beams can be the Top-N predicted beams
Notes: It is up to companies to provide other alternative(s). Beam ID is only used for discussion purposes. All the outputs are “nominal” and only for discussion purpose. The value of N is up to each company. All of the outputs in the above alternatives may vary based on whether the AI/ML model inference is at UE side or gNB side. The Top-N beam IDs might have been derived via post-processing of the ML-model output.
   For BM-Case1 and BM-Case2 with a UE-side AI/ML model, the necessity and potential BM-specific conditions/additional conditions for functionality(ies) and/or model(s) are considered at least from the following aspects:
information regarding model inference
Set A/Set B configuration
performance monitoring
data collection
assistance information
   For beam management use cases:
For model training, training data can be generated by UE/gNB.
For NW-side model inference, input data can be generated by UE and terminated at gNB.
For UE-side model inference, input data is internally available at UE.
For performance monitoring at the NW side, calculated performance metrics (if needed) or data needed for performance metric calculation (if needed) can be generated by UE and terminated at gNB.

### 7.1.3 Beam Management

### Items Considered for Studying the Necessity, Feasibility, Potential Specification Impact:

### Performance Monitoring:

For the performance monitoring of BM-Case1 and BM-Case2:
   Performance metric(s) with the following alternatives:
   Alt.1: Beam prediction accuracy related KPIs, e.g., Top-K/1 beam prediction accuracy
   Alt.2: Link quality related KPIs, e.g., throughput, L1-RSRP, L1-SINR, hypothetical BLER
   Alt.3: Performance metric based on input/output data distribution of AI/ML
   Alt.4: The L1-RSRP difference evaluated by comparing measured RSRP and predicted RSRP
Benchmark/reference for the performance comparison, including:
   Alt.1: The best beam(s) obtained by measuring beams of a set indicated by gNB (e.g., Beams from Set A)
   Alt.4: Measurements of the predicted best beam(s) corresponding to model output (e.g., Comparison between actual L1-RSRP and predicted RSRP of predicted Top-1/K Beams)
Signalling/configuration/measurement/report for model monitoring, e.g., signalling aspects related to assistance information (if supported), Reference signals
   For BM-Case1 and BM-Case2 with a UE-side AI/ML model:
Type 1 performance monitoring:
   Configuration/Signalling from gNB to UE for measurement and/or reporting
   UE may have different operations
      Option 1 (NW-side performance monitoring): UE sends reporting to NW (e.g., for the calculation of performance metric at NW)
      Option 2 (UE-assisted performance monitoring): UE calculates performance metric(s), either reports it to NW or reports an event to NW based on the performance metric(s)
   Indication from NW for UE to do LCM operations
   Note: At least the performance and reporting overhead of model monitoring mechanism should be considered
Type 2 performance monitoring:
   Indication/request/report from UE to gNB for performance monitoring
      Note: The indication/request/report may be not needed in some case(s)
   Configuration/Signalling from gNB to UE for performance monitoring measurement and/or reporting
   If it is for UE side model monitoring, UE makes decision(s) of model selection/activation/deactivation/switching/fallback operation
Mechanism that facilitates the UE to detect whether the functionality/model is suitable or no longer suitable
   For BM-Case1 and BM-Case2 with a NW-side AI/ML model
Beam measurement and report for model monitoring
   UE reporting of beam measurement(s) based on a set of beams indicated by gNB.
   Signalling, e.g., RRC-based, L1-based.
   Note: This may or may not have specification impact.
NW monitors the performance metric(s) and makes decision(s) of model selection/activation/deactivation/switching/fallback operation
Note: Performance and UE complexity, power consumption should be considered.
   Table 7.2.3-1 summarizes applicability of various alternatives for performance metric(s) of AI/ML model monitoring for BM-Case1 and BM-Case2.

TABLE 7.2.3-1
Alternatives for Performance metric(s) of AI/ML model monitoring for BM-Case 1 and BM-Case 2

| Alt. 1: Beam | | Alt. 3: | |
|---|---|---|---|
| prediction accuracy | Alt. 2: Link quality | Performance metric | Alt. 4: The L1-RSRP |
| related KPIs, e.g., Top- | related KPIs, .e.g., | based on input/output | difference evaluated by |
| K/1 beam prediction | throughput, L1-RSRP, L1- | data distribution of | comparing measured RSRP |
| accuracy | SINR, hypothetical BLER | AI/ML | and predicted RSRP |
| Applicable to all studied | Applicable to all studied | Applicable to all studied | May not applicable to some |
| AI models | AI models | AI models | implementation of AI model |
| | | | (e.g., not output of predicted |
| | | | L1-RSRP) |
| Reflect the prediction | Reflect the system/link | Reflect the change of the | Reflect accuracy of the |
| accuracy of AI model | performance | statics of the input/output | predicted 1-RSRP |
| | | data | |
| Not reflect the system/link | Not reflect the prediction | Not reflect the prediction | Not reflect the system/link |
| performance directly | accuracy of AI model | performance of AI model | performance directly |
| | directly | directly | |
| | | Not reflect the system/link | |
| | | performance directly | |

Note1:
The above analysis shall not give an indication about whether/which metric is supported or specified.
Note2:
Monitoring performance of the above alternatives are not addressed in the table.

### Data Collection:

At UE side for UE-side AI/ML model:
UE reporting to NW supported/preferred configurations of DL RS transmission.
Trigger/initiating data collection considering:
   Option 1: data collection initiated/triggered by configuration from NW.
   Option 2: request from UE for data collection.
Signalling/configuration/measurement/report for data collection, e.g., signalling aspects related to assistance information (if supported), Reference signals, content/type of the collected data, configuration related to Set A and/or Set B, information on association/mapping of Set A and Set B
Assistance information from Network to UE for UE data collection for categorizing the data for the purpose of differentiating characteristics of the data (if supported). The assistance information should preserve privacy/proprietary information.
   At NW side for NW-side AI/ML model:
Mechanism related to the reporting.
Additional information for content of the reporting.
Reporting overhead reduction.
Signalling/configuration/measurement/report for data collection, e.g., signalling aspects related to assistance information (if supported), Reference signals.
   Regarding data collection for NW-side AI/ML model regarding the contents of collected data:
Opt.1: M1 L1-RSRPs (corresponding to M1 beams) with the indication of beams (beam pairs) based on the measurement corresponding to a beam set, where M1 can be larger than 4, if applicable.
Opt.2: M2 L1-RSRPs (corresponding to M2 beams) based on the measurement corresponding to a beam set, where M2 can be larger than 4, if applicable.
Opt.3: M3 beam (beam pair) indices based on the measurement corresponding to a beam set, where M3 can be larger than 4, if applicable.
Note: Overhead, UE complexity and power consumption are to be considered for the above options.
   Regarding data collection for NW-side AI/ML model of BM-Case1 and BM-Case2, the following approaches have been identified for overhead reduction:
the omission/selection of collected data
the compression of collected data
Note1: For the different purposes of data collection, the overhead reduction mechanisms and corresponding specification impacts may be different.
   Note2: Support of any mechanism(s) (if necessary) for each LCM purpose and the potential spec impact (if any) are separate discussions
   Note 3: UE complexity and power consumption should be considered
      Regarding data collection for NW-side AI/ML model of BM-Case1 and BM-Case2, the following reporting signalling for beam-specific aspects maybe applicable:
L1 signalling to report the collected data
Higher-layer signalling to report the collected data
   At least not applicable to AI/ML model inference
Note1: Higher layer signalling design is up to RAN2
Note2: Whether each signalling applicable to each LCM purpose is a separate discussion
Note3: The legacy signalling principle (e.g. RSRP reporting for L1) can be re-used

### Model Inference Related:

In order to facilitate the AI/ML model inference:
Enhanced or new configurations/UE reporting/UE measurement, e.g., enhanced or new beam measurement and/or beam reporting
Enhanced or new signalling for measurement configuration/triggering
Signalling of assistance information (if applicable)
   For BM-Case1 and BM-Case2 with a UE-side AI/ML model:
Indication of the associated Set A from network to UE, e.g., association/mapping of beams within Set A and beams within Set B if applicable
Beam indication from network for UE reception, which may or may not have additional specification impact (e.g., legacy mechanism may be reused), particularly:
   how to perform beam indication of beams in Set A not in Set B. Note: also applicable to NW-side AI/ML model. Note: At least for BM-Case1 with a UE-side AI/ML model, the legacy TCI state mechanism can be used to perform beam indication of beams
Note: For DL beam pair prediction, there is no consensus to support the reporting of the predicted Rx beam(s) (e.g., Rx beam ID, Rx beam angle information, etc) from the UE to the network.
Predicted L1-RSRP(s) corresponding to the DL Tx beam(s) or beam pair(s)
   Whether/how to differentiate predicted L1-RSRP and measured L1-RSRP
Confidence/probability information related to the output of AI/ML model inference (e.g., predicted beams)
   For BM-Case1 and BM-Case2 with a NW-side AI/ML model:
L1 beam reporting enhancement for AI/ML model inference:
   UE to report the measurement results of more than 4 beams in one reporting instance
   Other L1 reporting enhancements can be considered
For BM-Case1 with a UE-side AI/ML model:
   L1 signalling to report the following information of AI/ML model inference to NW:
      The beam(s) that is based on the output of AI/ML model inference.
         For BM-Case2 with a UE-side AI/ML model:
L1 signalling to report the following information of AI/ML model inference to NW:
   The beam(s) of N future time instance(s) that is based on the output of AI/ML model inference.
   Information about the timestamp corresponding the reported beam(s).

### For BM-Case 2:

Reporting information about measurements of multiple past time instances in one reporting instance. Notes: Only applicable to NW-side AI/ML model. The potential performance gains of measurement reporting should be justified by considering UCI payload overhead.

### Assistance Information:

Regarding the explicit assistance information from UE to network for NW-side AI/ML model, RAN1 has no consensus to support the following information
UE location
UE moving direction
UE Rx beam shape/direction
   Regarding the explicit assistance information from network to UE for UE-side AI/ML model, RAN1 has no consensus to support the following information
NW-side beam shape information
   E.g., 3 dB beamwidth, beam boresight directions, beam shape, Tx beam angle, etc.
Note: Other information (e.g., relative information) of Tx beam(s) preserving sensitive proprietary information is a separate discussion
   e.g., some information following the same principle of Rel-17 positioning agreement
      For BM-Case1 and BM-Case2 with a UE-side AI/ML model, consistency/association of Set B beams and Set A beams across training and inference is beneficial from performance perspective.
      Note: Whether specification impact is needed is a separate discussion.
      . . .

### 7.2 Protocol Aspects

In this clause, considering the use cases and as per RAN1 input, aspects related to life cycle management signalling procedures, model identification, data collection, model transfer/delivery, UE capability reporting, and applicability-related reporting are studied.

### 7.2.1 Common Framework

### 7.2.1.1 Signalling Procedures for Model and Functionality Life Cycle Management

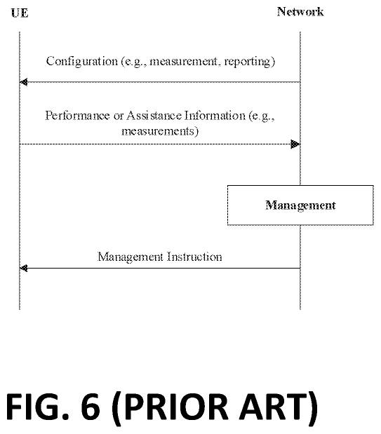

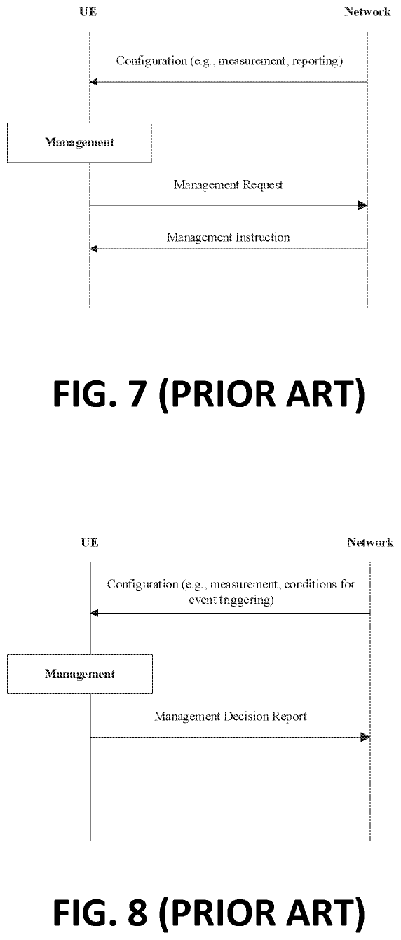

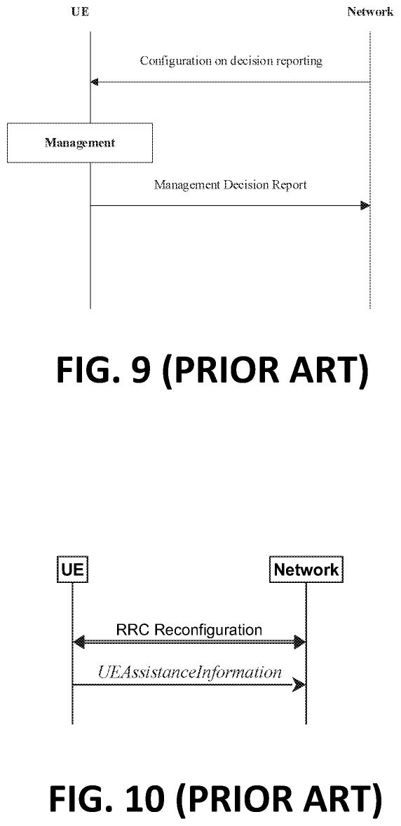

As per the functional framework in Figure 4.4-1, in this clause the signalling procedures for different scenarios for model-ID-based management and/or functionality-based management are exemplified. The procedures can at least be considered for UE-side models. From clause 4.2, these can include scenarios for which the management decision is taken by the network or by the UE. For network-side decision, this can be either network-initiated, or UE-initiated and requested to the network. While for UE-side decision, this can be either event-triggered as configured by the network and where the UE's decision is reported to the network, or UE-autonomous, with or without UE's decision being reported to the network.
Note: The mapping of these scenarios to specific use cases can be left to RAN1.
Note: The scenarios discussed below shall not imply support for all potential functionality and/or model Management Instructions (e.g., (de) activation, selection, switching, fallback, etc.) for every use case.
Note: In the figures below, Management Request/Management Instruction/Management Decision Report may include details about the model/functionality selection, (de) activation, switching or fallback.
   Decision by the network
      Network-initiated
         FIG. 6 is a reproduction of Figure 7.2.1.1-1: Network decision, network-initiated AI/ML management, from 3GPP TR 38.843 V18.0.0 (2023-12) 3GPP.
         The case where the LCM decision is taken and initiated by the network is depicted in Figure 7.2.1.1-1.
Note: The Management Instruction may be a result of model/functionality performance monitoring at the network.
Note: The Management Instruction may include information about the model or functionality.
   UE-initiated and requested to the network
      FIG. 7 is a reproduction of Figure 7.2.1.1-2: Network decision, UE-initiated AI/ML management, from 3GPP TR 38.843 V18.0.0 (2023-12) 3GPP.
      The case where the LCM decision is taken by the network but where the request is initiated by the UE is depicted in Figure 7.2.1.1-2.
Note: The Management Request may be a result of model/functionality monitoring at the UE.
Note: In response to the Management Request, the network may send a Management Instruction to the UE.
Note: The Management Request may include information about the model or functionality.
Note: The network may accept or reject the Management Request from the UE.
Note: The Management Request may include information related to model/functionality performance metrics.
Note: The Management Instruction may include information about the model or functionality.
   Decision by the UE
      Event-triggered as configured by the network, UE's decision is reported to the network
         FIG. 8 is a reproduction of Figure 7.2.1.1-3: UE decision, event-triggered as configured by the network, from 3GPP TR 38.843 V18.0.0 (2023-12) 3GPP.
         The case where the LCM decision is taken by the UE according to prior network configuration is depicted in Figure 7.2.1.1-3.
Note: Use case-specific events/conditions may be configured by the network for event-triggered AI/ML management at the UE.
Note: UE may send a Management Decision Report to the network following event-triggered AI/ML management at the UE.
Note: The Management Decision Report may include information about the model or functionality.
   UE-autonomous, UE's decision is reported to the network
      FIG. 9 is a reproduction of Figure 7.2.1.1-4: UE autonomous, decision reported to the network, from 3GPP TR 38.843 V18.0.0 (2023-12) 3GPP.
      The case where the LCM decision can autonomously be taken by the UE is depicted in Figure 7.2.1.1-4.
Note: The UE may be configured to send a Management Decision Report to the network upon performing a model/functionality Management Decision.
   UE-autonomous, UE's decision is not reported to the network
      For the case where the LCM decision can autonomously be taken by the UE and where the decision is not reported to the network, the AI/ML management is transparent from a network perspective.

### 7.2.1.2 Model Identification and Meta Information

According to the functional framework in Figure 4.4-1, a model ID can be used within functions and for different data/information/instruction flows to identify an AI/ML model. For example, a model ID could eventually be associated to the selection/(de) activation/switching of a model or linked to the “Model Transfer/Delivery” information.
RAN2 assumes that a model ID can be globally unique, e.g., allowing for proper model validation and model testing procedures.
Note: How to ensure model ID uniqueness is out of RAN2 scope.
Note: Details of model training, validation and testing are out of RAN2 scope.
   Additionally, to manage or control AI/ML models, some meta information about the models may be needed.
Note: Details on the relationship between model IDs and meta information for purposes of model control and management can be addressed during a normative phase.

### 7.2.1.3 Data Collection

Data collection plays a crucial role in enabling the different use cases. Therefore, it is important to define the best approaches for collecting data to support UE-side and network-side model inference, monitoring, and training.
Table 7.3.1.2-1 lists existing data collection mechanisms available in current RAN specifications for the UE to report measurements to another entity acting as termination point for this data. As highlighted in clause 4.2, the analysis/selection of the data collection frameworks should focus on the RRC CONNECTED state for both data generation and reporting. As such, the Table can provide useful insights into existing methods with respect to various categories identified as relevant for data collection method selection.

TABLE 7.3.1.2-1
Existing data collection methods identified.

| | | | | | | |
|---|---|---|---|---|---|---|
| Involved | | | | | | |
| network | RRC | Max | | | | |
| entity | state to | payload | | | | Security |
| (termination | generate | size per | Contents to | End-to-End report | | and |
| point) | data | reporting* | be collected | latency** | Report type | Privacy |

Method: Logged MDT

| | | | | | | |
|---|---|---|---|---|---|---|
| TCE/OAM | IDLE/ | <9 kbyte | L3 cell/beam | 1) Procedure latency***: | Upon gNB | AS security |
| (Data can | INACTIVE | | measurements | Latency to enter | request after | via RRC |
| be utilized | | | location | CONNECTED state | entering | message |
| by gNB) | | | information | Latency to receive gNB | RRC_CONNECTED | Privacy via |
| | | | sensor | request signalling | | user |
| | | | information | (~20 ms) | | consent |
| | | | timing | 2) Air interface signalling | | |
| | | | information | latency****: | | |
| | | | | ~20 ms (RRC) | | |
| | | | | 3) Other latency: | | |
| | | | | Forwarding latency | | |
| | | | | between gNB and TCE | | |

Method: Immediate MDT

| | | | | | | |
|---|---|---|---|---|---|---|
| TCE/OAM | CONNECTED | <9 kbyte | L3 cell/beam | 1) Procedure latency: | Event | AS security |
| (Data can | | | measurements | Report interval: | triggered | via RRC |
| be utilized | | | location | 120 ms~30 min for | Periodic | message |
| by gNB) | | | information | periodic report | reporting | Privacy via |
| | | | sensor | TTT for event | | user |
| | | | information | triggered report | | consent |
| | | | | 2) Air interface signalling | | |
| | | | | latency: | | |
| | | | | ~20 ms (RRC) | | |
| | | | | 3) Other latency: | | |
| | | | | Forwarding latency | | |
| | | | | between gNB and TCE | | |

Method: L3 measurements

| | | | | | | |
|---|---|---|---|---|---|---|
| gNB | CONNECTED | <9 kbyte | L3 cell/beam | 1) Procedure latency: | Event | AS security |
| | | | measurements | Report interval: | triggered | via RRC |
| | | | | I20 ms~30 min for | report | message |
| | | | | periodic report | Periodic | |
| | | | | TTT for event | reporting | |
| | | | | triggered report | | |
| | | | | 2) Air interface signalling | | |
| | | | | latency: | | |
| | | | | 20 ms (RRC) | | |

Method: L1 measurement (CSI reporting)

| | | | | | | |
|---|---|---|---|---|---|---|
| gNB | CONNECTED | <1706 bit in | L1 CSI | 1) Procedure latency: | Aperiodic | No AS |
| | | PUCCH | measurement | Report interval: | report | security |
| | | <3840 bit in | | 4-320 slot for | Semi- | |
| | | PUSCH | | periodic and semi- | persistent | |
| | | | | persistent report | report | |
| | | | | 0-32 slot after | Periodic | |
| | | | | reception of DCI for | report | |
| | | | | aperiodic report | | |
| | | | | 2) Air interface signalling | | |
| | | | | latency: | | |
| | | | | 1 TTI (PUCCH) | | |

Method: UE Assistance Information (UAI)

| | | | | | | |
|---|---|---|---|---|---|---|
| gNB | CONNECTED | <9 kbyte | Assistance | 1) Procedure latency: | Up to UE | AS security |
| | | | information to | Upon generation of UE's | implementation | via RRC |
| | | | show UE | preference | when to report | message |
| | | | preference | 2) Air interface signalling | | |
| | | | | latency: | | |
| | | | | ~20 ms (RRC) | | |

Method: Early measurements

| | | | | | | |
|---|---|---|---|---|---|---|
| gNB | IDLE/ | <9 kbyte | L3 cell/beam | 1) Procedure latency: | Upon gNB | AS security |
| | INACTIVE | | measurements | Latency to enter | request after | via RRC |
| | | | | CONNECTED state | entering | message |
| | | | | Latency to receive gNB | RRC_CONNECTED | |
| | | | | request signalling | | |
| | | | | (~20 ms) | | |
| | | | | 2) Air interface signalling | | |
| | | | | latency: | | |
| | | | | ~20 ms (RRC) | | |

Method: LPP

| | | | | | | |
|---|---|---|---|---|---|---|
| LMF | CONNECTED | <9 kbyte | Location | 1) Procedure latency: | UE-triggered | AS security |
| | | | information | Latency to get upper | Network- | via RRC |
| | | | | layer trigger (for UE | triggered | message |
| | | | | triggered) | | |
| | | | | Or latency to receive | | |
| | | | | network request | | |
| | | | | message (~20 ms) | | |
| | | | | 2) Air interface signalling | | |
| | | | | latency: | | |
| | | | | ~20 ms (RRC) | | |
| | | | | 3) Other latency: | | |
| | | | | Forwarding latency | | |
| | | | | between gNB and LMF | | |

*The payload size doesn't consider signalling overhead.
**The End-to-End report latency is the latency from availability of the measurement report at the UE side to the availability of the measurement report at the terminated network entity. The time to generate data or perform measurements depends on RAN1/RAN4 specification.
***Procedure latency is the latency caused by procedures, including procedure to ready for reporting (e.g., entering CONNECTED state, report interval).
****Air interface signalling latency is the latency to transmit one report, e.g., RRC signalling latency or PUCCH signalling latency.

### 7.2.1.3.1 Considerations for Network-Side Data Collection

A set of general data collection principles is expected to be considered for network-side model training. These include:
UE to support data logging,
UE to report the collected data periodically, event-based, and on-demand,
The UE memory, processing power, energy consumption, signalling overhead should be considered.
Note: The above principles can be revised depending on RAN1 requirements.
   Furthermore, and regarding the use cases in this study, the following is considered.
   For CSI and beam management use cases, the training of network-side models can consider both gNB and OAM-centric data collection mechanisms. The gNB-centric data collection implies that the gNB can configure the UE to initiate/terminate the data collection procedure. The potential impact of L3 signalling for the reporting of collected data should be assessed.
   On the other hand, OAM-centric data collection implies that the OAM provides the configuration (via the gNB) needed for the UE to initiate/terminate the data collection procedure. MDT framework can be considered to achieve this. The potential impact on MDT for RRC_CONNECTED state should be assessed.
   For positioning use cases, when considering LMF-side inference, it is assumed that the LPP protocol should be applied to the data collected by UE and terminated at LMF, while the NRPPa protocol should be applied to the data collected by gNB and terminated at LMF. While for LMF-side performance monitoring, it is assumed that the LPP protocol should be applied to the data collected by UE and terminated at LMF, while the NRPPa protocol should be applied to the data collected by gNB and terminated at LMF.
Note: For gNB- and OAM-centric data collection, there may be a need to consult with RAN3 and SA5 whether/how OAM is to be involved.
Note: For possible impacts due to positioning use cases, there may be a need to consult with RAN3 whether/how NRPPa is to be involved.

### 7.2.1.3.2 Data Collection for UE-Side Model Training

The following proposals were discussed in RAN2:
1. UE collects and directly transfers training data to the Over-The-Top (OTT) server;
   1a) OTT (TRansparent)
   1b) OTT (non-TRansparent)
2. UE collects training data and transfers it to Core Network. Core Network transfers the training data to the OTT server.
3. UE collects training data and transfers it to OAM. OAM transfers the needed data to the OTT server.
   RAN2 did not study or analyse these proposals and did not agree to requirements or recommendations.

### 7.2.1.4 Model Transfer/Delivery

Whether there is a need to consider standardised solutions for transferring/delivering AI/ML model(s) is unclear from the outcome of the present study. Nonetheless, to support AI/ML model transfer/delivery, the following solutions are considered:
Solution 1a: gNB can transfer/deliver AI/ML model(s) to UE via RRC signalling.
Solution 2a: Core Network (except LMF) can transfer/deliver AI/ML model(s) to UE via NAS signalling.
Solution 3a: LMF can transfer/deliver AI/ML model(s) to UE via LPP signalling.
Solution 1b: gNB can transfer/deliver AI/ML model(s) to UE via UP data.
Solution 2b: Core Network (except LMF) can transfer/deliver AI/ML model(s) to UE via User Plane (UP) data.
Solution 3b: LMF can transfer/deliver AI/ML model(s) to UE via UP data.
Solution 4a: OTT server can transfer/deliver AI/ML model(s) to UE (e.g., transparent to 3GPP).
Solution 4b: OAM can transfer/deliver AI/ML model(s) to UE.

Note: The relationships between model transfer/delivery solutions and use cases can be derived from what is captured in clauses 7.3.2, 7.3.3, and 7.3.4.

The following areas are considered to evaluate the different model transfer/delivery solutions:
A1: Large, no upper limit model/model parameter size,
A2: Model transfer/delivery continuity (i.e., resume transmission of model (segments) across gNBs),
A3: Network controllability on model transfer/delivery (e.g., management decision at gNB),
A4: Model transfer/delivery QoS (for DRB) (including latency, etc.) and priority (for SRB).
   For every model transfer/delivery solution, each of the above areas is analysed, focusing on the current status and gaps, and the potential impacts on RAN specification. The analysis is shown in the Tables below.

TABLE 7.3.1.4-1
Analysis of current status and gaps, and potential RAN specification impact for Solution 1a

| Discussion Area | Current status and Gaps | Potential RAN specification impact |
|---|---|---|
| A1. Large, no upper limit | Model size >45 kBytes is not | Extension of the number of RRC |
| model/model parameter size | supported based on existing number | segments is required to support |
| | of RRC segments | models larger than 45 kBytes |
| A2. Model transfer/delivery continuity | Transmission is restarted upon | Requires service continuity |
| (i.e., resume transmission of model | mobility | support for SRBs with |
| (segments) across gNBs) | | segmentations. |
| | | Xn/NGAP enhancement(s) for |
| | | model transfer/delivery |
| | | continuity |
| A3. Network controllability on model | Management and interaction | Requires management and |
| transfer/delivery and management at | between UE and gNB is not | interaction between UE and gNB |
| gNB | supported | (e.g., model identification, model |
| | | transfer completion indication, etc.) |
| | | when model management at gNB |
| A4. Model transfer/delivery QoS (for | Procedure latency depends on model | Impact on SRB in DL, e.g., a new |
| DRB) (including latency, etc.) and | size and SRB priority | SRB with configurable priority, etc. |
| priority (for SRB) | | |

TABLE 7.3.1.4-2
Analysis of current status and gaps, and potential RAN specification impact for Solutions 2a and 3a

| Discussion Area | Current status and Gaps | Potential RAN specification impact |
|---|---|---|
| A1. Large, no upper limit | Model size >45 kBytes is not | If NAS/LMF does not do |
| model/model parameter size | supported based on existing | segmentation for model |
| | number of RRC segments | transfer/delivery, it may need RRC |
| | Core Network supports NAS | segmentation, and extension of the |
| | signalling segmentation | number of RRC segments is required |
| | LMF supports LPP signalling | to support models larger than |
| | segmentation | 45 kBytes |
| A2. Model transfer/delivery continuity | Supported with limitation: | Note: Supporting service continuity |
| (i.e., resume transmission of model | For Solution 2a, support within | across AMF/LMF is out of RAN scope |
| (segments) across gNBs) | AMF coverage area based on | and needs coordination with Core |
| | NAS signalling segmentation | Network groups |
| | For Solution 3a, support within | |
| | LMF coverage area based on | |
| | LPP signalling segmentation | |
| A3. Network controllability on model | For Solution 2a, gNB cannot | Requires management and |
| transfer/delivery and management at | perform management directly, | model transfer interaction between |
| gNB | considering model transfer is | Core Network/LMF and gNB, e.g., via |
| | transparent to gNB | NAS signalling or NRPPa signalling |
| | Management and interaction | when model management at gNB |
| | between UE and gNB is not | Requires management and |
| | supported | interaction between UE and gNB |
| | | (e.g., model identification, model |
| | | transfer completion indication, etc.) |
| | | when model management at gNB |
| A4. Model transfer/delivery QoS (for | Procedure latency depends on model | Impact on SRB in DL, e.g., a new |
| DRB) (including latency, etc.) and | size and SRB priority; other latency | SRB with configurable priority, etc. |
| priority (for SRB) | includes forwarding NAS message | |
| | latency from Core Network to gNB | |

Note:
NAS and LMF upper limits and potential impacts to NAS and LPP specifications have not been studied and feasibility on filling gaps is unknown.

TABLE 7.3.1.4-3
Analysis of current status and gaps, and potential RAN specification impact for Solutions 1b

| Discussion Area | Current status and Gaps | Potential RAN specification impact |
|---|---|---|
| A1. Large, no upper limit | No model size limitation | Requires PDU session termination at |
| model/model parameter size | PDU session termination at | gNB if needed |
| | gNB is not supported | |
| A2. Model transfer/delivery continuity | Model transfer continuity if PDU | Identify a solution to support |
| (i.e., resume transmission of model | session terminated at gNB is not | service continuity support |
| (segments) across gNBs) | studied | between gNBs when PDU |
| | | session is terminated at gNB if |
| | | needed |
| | | Xn/NGAP enhancement(s) for |
| | | model transfer/delivery |
| | | continuity |
| A3. Network controllability on model | Management and interaction | Requires management and |
| transfer/delivery and management at | between UE and gNB appear to be | interaction between UE and gNB |
| gNB | feasible but not supported | (e.g., model identification, model |
| | | transfer completion indication, etc.) |
| | | when model management at gNB |
| A4. Model transfer/delivery QoS (for | Procedure latency depends on | Identify a solution to support QoS |
| DRB) (including latency, etc.) and | model size, QoS requirement | management at gNB for model |
| priority (for SRB) | and DRB priority | transfer when PDU session is |
| | QoS management at gNB if | terminated at gNB if needed |
| | PDU session is terminated at | |
| | gNB is not supported | |

TABLE 7.3.1.4-4
Analysis of current status and gaps, and potential RAN specification impact for Solutions 2b and 3b

| Discussion Area | Current status and Gaps | Potential RAN specification impact |
|---|---|---|
| A1. Large, no upper limit | No model size limitation | No RAN impact |
| model/model parameter size | | Note: The detail procedure of |
| | | model transfer from Core |
| | | Network/LMF to UE is out of |
| | | RAN scope |
| A2. Model transfer/delivery continuity | For Solution 2b, supported | Note: supporting service continuity |
| (i.e., resume transmission of model | For Solution 3b, depends on | across LMF is out of RAN scope |
| (segments) across gNBs) | Rel-18 CT1 solution LPP | |
| | message over a user plane | |
| | connection between UE and | |
| | LMF | |
| A3. Network controllability on model | gNB cannot perform model | Requires management and model |
| transfer/delivery and management at | management directly | transfer interaction between Core |
| gNB | | Network/LMF and gNB when model |
| | | management at gNB |
| | Management and interaction | Requires management and |
| | between UE and gNB is not | interaction between UE and gNB |
| | supported | (e.g., model identification, model |
| | | transfer completion, etc.) when model |
| | | management at gNB |
| A4. Model transfer/delivery QoS (for | Procedure latency depends on | Note: The detail QoS requirement on |
| DRB) (including latency, etc.) and | model size, QoS requirement and | Core Network for model |
| priority (for SRB) | DRB priority | transfer/delivery is out of RAN scope |
| | Other latency includes | |
| | forwarding data from Core Network to | |
| | gNB | |

TABLE 7.3.1.4-5
Analysis of current status and gaps, and potential RAN specification impact for Solutions 4a

| Discussion Area | Current status and Gaps | Potential RAN specification impact |
|---|---|---|
| A1. Large, no upper limit | No model size limitation | No RAN impact |
| model/model parameter size | | |
| A2. Model transfer/delivery continuity | If model transfer/delivery from | Note: supporting service continuity |
| (i.e., resume transmission of model | OTT server via Core Network, | across LMF is out of RAN scope |
| (segments) across gNBs) | supported | |
| | If model transfer/delivery from | |
| | OTT server via LMF, depends | |
| | on Rel-18 CT1 solution LPP | |
| | message over a User Plane | |
| | connection between UE and | |
| | LMF | |
| A3. Network controllability on model | Model transfer/delivery is transparent | Requires management and |
| transfer/delivery and management at | to RAN | model transfer interaction |
| gNB | | between OTT server and gNB |
| | | when model management at |
| | | gNB |
| | | Note: it is unclear whether this |
| | | is within RAN scope |
| | | Requires interaction between |
| | | UE and gNB for the network |
| | | controllability of the model |
| | | transfer/delivery (e.g., model |
| | | identification, model transfer |
| | | completion, etc.) if |
| | | management is in gNB |
| A4. Model transfer/delivery QoS (for | Procedure latency depends on | Note: The detail QoS requirement for |
| DRB) (including latency, etc.) and | model size, QoS requirement | model transfer/delivery of solution 4a |
| priority (for SRB) | and DRB priority | is out of RAN scope |
| | Other latency includes | |
| | forwarding data from OTT | |
| | server to gNB | |

TABLE 7.3.1.4-6
Analysis of current status and gaps, and potential RAN specification impact for Solutions 4b

| | | Potential RAN specification impact |
|---|---|---|
| | | (Note: whether and how to support |
| | | model transfer/delivery from OAM |
| | | to gNB and OAM to UE directly is |
| Discussion Area | Current status and Gaps | out of RAN scope) |
| A1. Large, no upper limit | Over Control Plane (CP) | Over Control Plane (CP) |
| model/model parameter size | signalling: model size >45 | signalling: If OAM does not do |
| | kBytes is not supported | segmentation for model |
| | based on existing number of | transfer/delivery, it may need |
| | RRC segments if OAM does | RRC segmentation, and |
| | not do segmentation for model | extend RRC segment number |
| | transfer/delivery | if model size larger than |
| | Over, e.g., IP: no model size | 45 kBytes |
| | limitation, but direct | Over, e.g., IP: NOTE: whether |
| | connection between OAM and | and how to support direct |
| | UE is not supported | connection between OAM and |
| | | UE is out of RAN scope |
| A2. Model transfer/delivery continuity | Support within OAM coverage | |
| (i.e., resume transmission of model | | |
| (segments) across gNBs) | | |
| A3. Network controllability on model | gNB cannot perform model | Note: support management and |
| transfer/delivery and management at | management directly | model transfer interaction between |
| gNB | | OAM and gNB is out of RAN scope |
| A4. Model transfer/delivery QoS (for | Over Control Plane (CP) | Over Control Plane (CP) |
| DRB) (including latency, etc.) and | signalling: | signalling: |
| priority (for SRB) | 1) Procedure latency | Note: The detail QoS |
| | depends on model size | requirement for model |
| | and SRB priority | transfer/delivery of solution 4b |
| | 2) other latency includes | is out of RAN scope |
| | forwarding data from OAM | Over, e.g., IP: |
| | to gNB | Note: whether and how to |
| | Over, e.g., IP: direct | support latency, QoS |
| | connection between OAM and | requirement between OAM |
| | UE is not supported | and UE is out of RAN scope |

Note:
For Solution 4b, RAN2 discussed the following two solutions but did not study or analyse their feasibility:
OAM can transfer/deliver AI/ML models to UE via OAM→RAN→UE, where Control Plane (CP) signalling is used for RAN→UE.
OAM can transfer/deliver AI/ML models to UE via OAM→UE, e.g., via IP tunnel.

A reactive and a proactive approach for initiating a model transfer/delivery can be considered in a normative phase. For the reactive approach, an AI/ML model is transferred/delivered (i.e., downloaded) to the UE when needed. This could typically happen due to changes in scenarios, configurations, sites, etc. While for the proactive model transfer/delivery approach, an AI/ML model is pre-download to the UE, and a model switch can typically be performed due to changes in scenarios, configurations, sites, etc.

### 7.2.1.5 UE Capability Reporting

The legacy UE capability framework serves as the baseline to report UE's supported AI/ML-enabled Feature/FG. Therefore, for CSI and beam management use cases, this information is indicated in UE AS capability in RRC (e.g., UECapabilityEnquiry/UECapabilityInformation). While for positioning use cases, it is indicated by the positioning capability as defined in LPP.
Further discussions concerning UE capability details (e.g., granularity of Feature/FG, content, structure of the related UE capabilities, etc.) can be carried during a normative phase.

### 7.2.1.6 Reporting Applicability-Related Information

AI/ML models for a given use case may be tailored towards and applicable to specific scenarios, locations, configuration, deployments, among other factors. In this regard, it is acknowledged that AI/ML models may undergo updates, such as model changes, as an inherent part of their development. Therefore, to ensure efficient network control and management, especially associated to what concerns the UE-side, UEs might have the ability to indicate relevant information about their supported AI/ML models and concerning AI/ML functionalities to the network. This can allow the network to perform decisions regarding, e.g., the (de) activation, or switching of AI/ML functionalities and AI/ML models.
The previously mentioned information could in principle be understood as “applicability-related information” in which the UE could, for example, report to the network conditions under which a model/functionality is applicable/suitable, or whether model(s)/functionality(es) are (non) applicable under the current context. Note, however, that the existing UE capability reporting framework cannot be used for such purposes.
Note: How and whether there is a need to enable UEs to report applicability-related information can be further discussed and defined in a normative phase. Mechanisms such as UE Assistance Information can eventually be used as example.
   Two UE reporting types are identified to convey this additional information:
“reactive” reporting, and
“proactive” reporting.
   A reactive reporting would involve the UE to provide information to the network upon receiving an action from it.
   While a proactive reporting would involve the UE to provide information to the network without necessarily receiving an action from it. For example, the UE might proactively inform the RAN of updates/changes to its supported model(s) or functionality(es).
Note: Whether necessary signalling from network is needed for proactive UE reporting can be discussed in a normative phase.
Note: Whether there is a need for the network to report to the UE applicability-related information of AI/ML models and/or AI/ML functionalities can be discussed in a normative phase.

### 7.2.2 CSI Feedback Enhancement

The following set of objectives have been identified for the two-sided CSI compression use case. Firstly, to ensure that the UE part and network part of the models are configured and applied according to their applicable scenarios and configuration. Secondly, to ensure that models match properly, ensuring that the CSI generation part used at the UE corresponds to the CSI reconstruction part employed at the gNB. Thirdly, to allow for seamless operation, requiring the simultaneous (de) activation and switching of the two-sided model.
Regarding the last point above, for the two-sided model CSI compression use cases, the selection, (de) activation, switching, and fallback of AI/ML models or AI/ML functionalities can be initiated by either the UE or the gNB. For which it is important to distinguish the various cases and understand their applicability to UE-side versus network-side models.
For data collection, model transfer/delivery, and function-to-entity mapping analysis, various scenarios unfold for both the two-sided CSI compression use case, as well as for the UE-side CSI prediction use case, when the data generation and termination entities differ. For instance, for:
Model Training:
   For the two-sided CSI compression use case, training data can be generated by either the UE or the gNB, depending on specific requirements, while the termination point for training data may include the gNB, OAM, Over-The-Top (OTT) server or UE.
      Note: RAN2 identified the case in which Core Network may be used for model training. However, no study was conducted since this is beyond the scope of this Working Group.
   For the UE-side CSI prediction use case, training data can be generated by the UE, while the termination point for training data may include the UE or a UE-side OTT server.
      Note: RAN2 identified the cases in which OAM or Core Network may be used for UE-side model training. However, no study was conducted since this is beyond the scope of this Working Group.
      Note: RAN2 identified the case in which gNB may be used for UE-side model training. However, no conclusion was reached, as this depends on the RAN1 progress.
Inference:
   For the two-side CSI compression use case:
      For network part of two-sided model inference, the UE can generate the necessary input data while the termination point for this input data lies within the gNB, where the inference process is performed.
      For UE part of two-sided model inference, input data is internally available at UE, where the inference process is performed.
   For the UE-side CSI prediction use case:
      For UE-side model inference, input data is internally available at UE, where the inference process is performed.
Management:
   For the two-sided CSI compression use case, the model/functionality control (e.g., selection, (de) activation, switching, fallback, etc.) is performed by the gNB.
      Note: RAN2 identified the case in which the control is performed by the UE. However, no conclusion was reached, as this depends on the RAN1 progress.
   For the UE-side CSI prediction use case:
      The model/functionality control (e.g., selection, (de) activation, switching, fallback, etc.) may be performed by the UE when the monitoring resides within the UE.
      The model/functionality control (e.g., selection, (de) activation, switching, fallback, etc.) may be performed by the gNB when the monitoring resides within the gNB or UE.
   Monitoring:
      The UE monitors the performance of its UE-side model.
      For monitoring at the network side of UE-side model, the UE can generate, if needed, calculated performance metrics or data required for performance metric calculation, while the termination point for these is the gNB.

### 7.2.3 Beam Management

For beam management, the selection, (de) activation, switching, and fallback of models or functionalities can also be initiated by either the UE or the gNB. For which it is important to distinguish the various cases and understand their applicability to UE-side versus network-side models.
For data collection, model transfer/delivery, and function-to-entity mapping analysis, various scenarios unfold when the data generation and termination entities differ. For instance, for:
Model Training:
   For UE-side models, training data can be generated by the UE, while the termination point for training data may include the UE or a UE-side OTT server.
      Note: RAN2 identified the cases in which OAM or Core Network may be used for UE-side model training. However, no study was conducted since this is beyond the scope of this Working Group.
      Note: RAN2 identified the case in which gNB may be used for UE-side model training. However, no conclusion was reached, as this depends on the RAN1 progress.
   For gNB-side models, training data can be generated by the gNB or UE, while the termination point for training data may include the gNB, or OAM.
      Note: RAN2 identified the case in which OTT server and Core Network may be used for gNB-side model training. However, no study was conducted since this is beyond the scope of this Working Group.
Inference:
   For UE-side model inference, input data is internally available at UE, where the inference process is performed.
   For network-side model inference, the UE can generate the necessary input data while the termination point for this input data lies within the gNB, where the inference process is performed.
Management:
   For UE-side model, the model/functionality control (e.g., selection, (de) activation, switching, fallback, etc.) may be performed by the UE when the monitoring resides within the UE.
   For UE-side model, the model/functionality control (e.g., selection, (de) activation, switching, fallback, etc.) may be performed by the gNB when the monitoring resides within the gNB or UE.
   Monitoring:
      The UE monitors the performance of its UE-side model.
      For monitoring at the network side of UE-side model, the UE can generate, if needed, calculated performance metrics or data required for performance metric calculation, while the termination point for these is the gNB.
      For network-side model, the monitoring resides within the gNB.

### ******************************END OF QUOTATION [2]******************************

In TS 38.331 ([3] 3GPP TS 38.331 V18.3.0 (2024-09) 3GPP; TSG RAN; NR; Radio Resource Control (RRC) protocol specification (Release 18)), the following is provided:

### ******************************START OF QUOTATION [3]******************************

### 5.3.5.3 Reception of an RRCReconfiguration by the UE

The UE shall perform the following actions upon reception of the RRCReconfiguration, upon execution of the conditional reconfiguration (CHO, CPA, CPC, or subsequent CPAC), or upon execution of an LTM cell switch:
. . .
1> if the RRCReconfiguration message includes the otherConfig:
2> perform the other configuration procedure as specified in 5.3.5.9;
   . . .

### 5.3.5.9 Other Configuration

The UE shall:
1> if the received otherConfig includes the delayBudgetReportingConfig:
   2> if delayBudgetReportingConfig is set to setup:
      3> consider itself to be configured to send delay budget reports in accordance with 5.7.4;
   2> else:
      3> consider itself not to be configured to send delay budget reports and stop timer T342, if running.
. . .

### ******************************NEXT QUOTATION [3]******************************

### 5.7.4 UE Assistance Information

### 5.7.4.1 General

FIG. 10 is a reproduction of Figure 5.7.4.1-1: UE Assistance Information, from 3GPP TS 38.331 V18.3.0 (2024-09) 3GPP.
The purpose of this procedure is for the UE to inform the network of:
its delay budget report carrying desired increment/decrement in the connected mode DRX cycle length; or
. . .

### 5.7.4.2 Initiation

A UE capable of providing delay budget report in RRC_CONNECTED may initiate the procedure in several cases, including upon being configured to provide delay budget report and upon change of delay budget preference.
. . .
Upon initiating the procedure, the UE shall:
1> if configured to provide delay budget report:
   2> if the UE did not transmit a UEAssistanceInformation message with delayBudgetReport since it was configured to provide delay budget report; or
   2> if the current delay budget is different from the one indicated in the last transmission of the UEAssistanceInformation message including delayBudgetReport and timer T342 is not running:
      3> start or restart timer T342 with the timer value set to the delayBudgetReportingProhibitTimer;
      3> initiate transmission of the UEAssistanceInformation message in accordance with 5.7.4.3 to provide a delay budget report;
. . .

### 5.7.4.3 Actions Related to Transmission of UEAssistanceInformation Message

The UE shall set the contents of the UEAssistanceInformation message as follows:
1> if transmission of the UEAssistanceInformation message is initiated to provide a delay budget report according to 5.7.4.2 or 5.3.5.3;
   2> set delayBudgetReport to type1 according to a desired value;
. . .
   The UE shall:
. . .
2> submit the UEAssistanceInformation message to lower layers for transmission.

### ******************************NEXT QUOTATION [3]******************************

### 6.2.2 Message Definitions

UEAssistanceInformation
   The UEAssistanceInformation message is used for the indication of UE assistance information to the network.
Signalling radio bearer: SRB1, SRB3
RLC-SAP: AM
Logical channel: DCCH
Direction: UE to Network

UEAssistanceInformation message

| | |
|---|---|
| UEAssistanceInformation ::= | SEQUENCE { |
| criticalExtensions | CHOICE { |
| ueAssistanceInformation | UEAssistanceInformation-IEs, |
| criticalExtensionsFuture | SEQUENCE { } |

}
}

| UEAssistanceInformation-IEs ::= | SEQUENCE { | |
|---|---|---|
| delayBudgetReport | DelayBudgetReport | OPTIONAL, |
| lateNonCriticalExtension | OCTET STRING | OPTIONAL, |
| nonCriticalExtension | UEAssistanceInformation-v1540-IEs | OPTIONAL |

}
...

### ******************************NEXT QUOTATION [3]******************************

### 6.3.2 Radio Resource Control Information Elements

CSI-MeasConfig
   The IE CSI-MeasConfig is used to configure CSI-RS (reference signals) belonging to the serving cell in which CSI-MeasConfig is included, channel state information reports to be transmitted on PUCCH on the serving cell in which CSI-MeasConfig is included and channel state information reports on PUSCH triggered by DCI received on the serving cell in which CSI-MeasConfig is included. See also TS 38.214 [19], clause 5.2.

CSI-MeasConfig information element

| CSI-MeasConfig ::= | SEQUENCE { | |
|---|---|---|
| nzp-CSI-RS-ResourceToAddModList | SEQUENCE (SIZE (1..maxNrofNZP-CSI-RS-Resources)) OF NZP-CSI-RS-Resource | OPTIONAL, -- Need N |
| nzp-CSI-RS-ResourceToReleaseList | SEQUENCE (SIZE (1..maxNrofNZP-CSI-RS-Resources)) OF NZP-CSI-RS-ResourceId | OPTIONAL, -- Need N |
| nzp-CSI-RS-ResourceSetToAddModList | SEQUENCE (SIZE (1..maxNrofNZP-CSI-RS-ResourceSets)) OF NZP-CSI-RS-ResourceSet | |
| | | OPTIONAL, -- Need N |
| nzp-CSI-RS-ResourceSetToReleaseList | SEQUENCE (SIZE (1..maxNrofNZP-CSI-RS-ResourceSets)) OF NZP-CSI-RS-ResourceSetId | |
| | | OPTIONAL, -- Need N |
| csi-IM-ResourceToAddModList | SEQUENCE (SIZE (1..maxNrofCSI-IM-Resources)) OF CSI-IM-Resource | OPTIONAL, -- Need N |
| csi-IM-ResourceToReleaseList | SEQUENCE (SIZE (1..maxNrofCSI-IM-Resources)) OF CSI-IM-ResourceId | OPTIONAL, -- Need N |
| csi-IM-ResourceSetToAddModList | SEQUENCE (SIZE (1..maxNrofCSI-IM-ResourceSets)) OF CSI-IM-ResourceSet | OPTIONAL, -- Need N |
| csi-IM-ResourceSetToReleaseList | SEQUENCE (SIZE (1..maxNrofCSI-IM-ResourceSets)) OF CSI-IM-ResourceSetId | OPTIONAL, -- Need N |
| csi-SSB-ResourceSetToAddModList | SEQUENCE (SIZE (1..maxNrofCSI-SSB-ResourceSets)) OF CSI-SSB-ResourceSet | OPTIONAL, -- Need N |
| csi-SSB-ResourceSetToReleaseList | SEQUENCE (SIZE (1..maxNrofCSI-SSB-ResourceSets)) OF CSI-SSB-ResourceSetId | OPTIONAL, -- Need N |
| csi-ResourceConfigToAddModList | SEQUENCE (SIZE (1..maxNrofCSI-ResourceConfigurations)) OF CSI-ResourceConfig | |
| | | OPTIONAL, -- Need N |
| csi-ResourceConfigToReleaseList | SEQUENCE (SIZE (1..maxNrofCSI-ResourceConfigurations)) OF CSI-ResourceConfigId | |
| | | OPTIONAL, -- Need N |
| csi-ReportConfigToAddModList | SEQUENCE (SIZE (1..maxNrofCSI-ReportConfigurations)) OF CSI-ReportConfig | OPTIONAL, -- Need N |
| csi-ReportConfigToReleaseList | SEQUENCE (SIZE (1..maxNrofCSI-ReportConfigurations)) OF CSI-ReportConfigId | |
| | | OPTIONAL, -- Need N |
| reportTriggerSize | INTEGER (0..6) | OPTIONAL, -- Need M |
| aperiodicTriggerStateList | SetupRelease { CSI-AperiodicTriggerStateList } | OPTIONAL, -- Need M |
| semiPersistentOnPUSCH-TriggerStateList | SetupRelease { CSI-SemiPersistentOnPUSCH-TriggerStateList } | OPTIONAL, -- Need M |
| ..., | | |
| [[ | | |
| reportTriggerSizeDCI-0-2-r16 | INTEGER (0..6) | OPTIONAL -- Need R |
| ]], | | |
| [[ | | |
| sCellActivationRS-ConfigToAddModList-r17 | SEQUENCE (SIZE (1..maxNrofSCellActRS-r17)) OF SCellActivationRS-Config-r17 | OPTIONAL, -- |
| Need N | | |
| sCellActivationRS-ConfigToReleaseList-r17 | SEQUENCE (SIZE (1..maxNrofSCellActRS-r17)) OF SCellActivationRS-ConfigId-r17 | OPTIONAL -- |

| Need N | |
|---|---|
| ]], | |
| [[ | |
| ltm-CSI-ReportConfigToAddModList-r18 | SEQUENCE (SIZE (1..maxNrofLTM-CSI-ReportConfigurations-r18)) OF LTM-CSI-ReportConfig-r18 |

OPTIONAL, -- Need N

| | |
|---|---|
| ltm-CSI-ReportConfigToReleaseList-r18 | SEQUENCE (SIZE (1..maxNrofLTM-CSI-ReportConfigurations-r18)) OF LTM-CSI-ReportConfigId-r18 |

OPTIONAL -- Need N

]]
}

CSI-MeasConfig field descriptions

aperiodicTriggerStateList
Contains trigger states for dynamically selecting one or more aperiodic and semi-persistent reporting configurations and/or triggering
one or more aperiodic CSI-RS resource sets for channel and/or interference measurement (see TS 38.214 [19], clause 5.2.1).
csi-IM-ResourceSetToAddModList
Pool of CSI-IM-ResourceSet which can be referred to from CSI-ResourceConfig or from MAC CEs.
csi-IM-ResourceToAddModList
Pool of CSI-IM-Resource which can be referred to from CSI-IM-ResourceSet.
csi-ReportConfigToAddModList
Configured CSI report settings as specified in TS 38.214 [19] clause 5.2.1.1.
csi-ResourceConfigToAddModList
Configured CSI resource settings as specified in TS 38.214 [19] clause 5.2.1.2.
csi-SSB-ResourceSetToAddModList
Pool of CSI-SSB-ResourceSet which can be referred to from CSI-ResourceConfig.
ltm-CSI-ReportConfigToAddModList
Configured CSI report settings for LTM as specified in TS 38.214 [19].
nzp-CSI-RS-ResourceSetToAddModList
Pool of NZP-CSI-RS-ResourceSet which can be referred to from CSI-ResourceConfig or from MAC CEs.
nzp-CSI-RS-ResourceToAddModList
Pool of NZP-CSI-RS-Resource which can be referred to from NZP-CSI-RS-ResourceSet.
reportTriggerSize, reportTriggerSizeDCI-0-2
Size of CSI request field in DCI (bits) (see TS 38.214 [19], clause 5.2.1.5.1). The field reportTriggerSize applies to DCI format 0_1 and
the field reportTriggerSizeDCI-0-2 applies to DCI format 0_2 (see TS 38.214 [19], clause 5.2.1.5.1).
scellActivationRS-ConfigToAddModList
Configured RS for fast SCell activation as specified in TS 38.214 [19] clause 5.2.1.5.3.

CSI-ReportConfig
   The IE CSI-ReportConfig is used to configure a periodic or semi-persistent report sent on PUCCH on the cell in which the CSI-ReportConfig is included, or to configure a semi-persistent or aperiodic report sent on PUSCH triggered by DCI received on the cell in which the CSI-ReportConfig is included (in this case, the cell on which the report is sent is determined by the received DCI). See TS 38.214 [19], clause 5.2.1.

CSI-ReportConfig information element

| CSI-ReportConfig ::= | SEQUENCE { | |
|---|---|---|
| reportConfigId | CSI-ReportConfId, | |
| carrier | ServCellIndex | OPTIONAL, -- Need S |
| resourcesForChannelMeasurement | CSI-ResourceConfigId, | |
| csi-IM-ResourcesForInterference | CSI-ResourceConfigId | OPTIONAL, -- Need R |
| nzp-CSI-RS-ResourcesForInterference | CSI-ResourceConfigId | OPTIONAL, -- Need R |

| reportConfigType | CHOICE { | |
|---|---|---|
| periodic | SEQUENCE { | |
| reportSlotConfig | CSI-ReportPeriodicityAndOffset, | |
| pucch-CSI-ResourceList | SEQUENCE (SIZE (1..maxNrofBWPs)) OF PUCCH-CSI-Resource | |
| }, | | |
| semiPersistentOnPUCCH | SEQUENCE { | |
| reportSlotConfig | CSI-ReportPeriodicityAndOffset, | |
| pucch-CSI-ResourceList | SEQUENCE (SIZE (1..maxNrofBWPs)) OF PUCCH-CSI-Resource | |
| }, | | |
| semiPersistentOnPUSCH | SEQUENCE { | |
| reportSlotConfig | ENUMERATED {sl5, sl10, sl20, sl40, sl80, sl160, sl320}, | |
| reportSlotOffsetList | SEQUENCE (SIZE (1.. maxNrofUL-Allocations)) OF INTEGER(0..32), | |
| p0alpha | P0-PUSCH-AlphaSetId | |
| }, | | |
| aperiodic | SEQUENCE { | |
| reportSlotOffsetList | SEQUENCE (SIZE (1..maxNrofUL-Allocations)) OF INTEGER(0..32) | |
| } | | |
| }, | | |
| reportQuantity | CHOICE { | |
| none | NULL, | |
| cri-RI-PMI-CQI | NULL, | |
| cri-RI-i1 | NULL, | |
| cri-RI-i1-CQI | SEQUENCE { | |
| pdsch-BundleSizeForCSI | ENUMERATED {n2, n4} | OPTIONAL -- Need S |
| }, | | |
| cri-RI-CQI | NULL, | |
| cri-RSRP | NULL, | |
| ssb-Index-RSRP | NULL, | |
| cri-RI-LI-PMI-CQI | NULL | |
| }, | | |
| reportFreqConfiguration | SEQUENCE { | |
| cqi-FormatIndicator | ENUMERATED { widebandCQI, subbandCQI } | OPTIONAL, -- Need R |
| pmi-FormatIndicator | ENUMERATED { widebandPMI, subbandPMI } | OPTIONAL, -- Need R |
| csi-ReportingBand | CHOICE { | |
| subbands3 | BIT STRING(SIZE(3)), | |
| subbands4 | BIT STRING(SIZE(4)), | |
| subbands5 | BIT STRING(SIZE(5)), | |
| subbands6 | BIT STRING(SIZE(6)), | |
| subbands7 | BIT STRING(SIZE(7)), | |
| subbands8 | BIT STRING(SIZE(8)), | |
| subbands9 | BIT STRING(SIZE(9)), | |
| subbands10 | BIT STRING(SIZE(10)), | |
| subbands11 | BIT STRING(SIZE(11)), | |
| subbands12 | BIT STRING(SIZE(12)), | |
| subbands13 | BIT STRING(SIZE(13)), | |
| subbands14 | BIT STRING(SIZE(14)), | |
| subbands15 | BIT STRING(SIZE(15)), | |
| subbands16 | BIT STRING(SIZE(16)), | |
| subbands17 | BIT STRING(SIZE(17)), | |
| subbands18 | BIT STRING(SIZE(18)), | |
| ..., | | |
| subbands19-v1530 | BIT STRING (SIZE(19)) | |
| } OPTIONAL -- Need S | | OPTIONAL, -- Need R |
| } | | |
| timeRestrictionForChannelMeasurements | ENUMERATED {configured, notConfigured}, | |
| timeRestrictionForInterferenceMeasurements | ENUMERATED {configured, notConfigured}, | |
| codebookConfig | CodebookConfig | OPTIONAL, -- Need R |
| dummy | ENUMERATED {n1, n2} | OPTIONAL, -- Need R |
| groupBasedBeamReporting | CHOICE { | |
| enabeled | NULL, | |
| disabled | SEQUENCE { | |
| nrofReportedRS | ENUMERATED {n1, n2, n3, n4} | OPTIONAL -- Need S |
| } | | |
| }, | | |
| cqi-Table | ENUMERATED {table1, table2, table3, table4-r17} | OPTIONAL, -- Need |
| R | | |
| subbandSize | ENUMERATED {value1, value2}, | |
| non-PMI-PortIndication | SEQUENCE (SIZE (1..maxNrofNZP-CSI-RS-ResourcesPerConfig)) OF PortIndexFor8Ranks | OPTIONAL, -- Need R |
| ..., | | |
| [[ | | |
| semiPersistentOnPUSCH-v1530 | SEQUENCE { | |
| reportSlotConfig-v1530 | ENUMERATED {sl4, sl8, sl16} | |
| } | | OPTIONAL -- Need R |
| ]], | | |
| [[ | | |
| semiPersistentOnPUSCH-v1610 | SEQUENCE { | |
| reportSlotOffsetListDCI-0-2-r16 | SEQUENCE (SIZE (1.. maxNrofUL-Allocations-r16)) OF INTEGER(0..32) | OPTIONAL, -- Need R |
| reportSlotOffsetListDCI-0-1-r16 | SEQUENCE (SIZE (1.. maxNrofUL-Allocations-r16)) OF INTEGER(0..32) | OPTIONAL -- Need R |
| } | | OPTIONAL, -- Need R |
| aperiodic-v1610 | SEQUENCE { | |
| reportSlotOffsetListDCI-0-2-r16 | SEQUENCE (SIZE (1.. maxNrofUL-Allocations-r16)) OF INTEGER(0..32) | OPTIONAL, -- Need R |
| reportSlotOffsetListDCI-0-1-r16 | SEQUENCE (SIZE (1.. maxNrofUL-Allocations-r16)) OF INTEGER(0..32) | OPTIONAL -- Need R |
| } | | OPTIONAL, -- Need R |
| reportQuantity-r16 | CHOICE { | |
| cri-SINR-r16 | NULL, | |
| ssb-Index-SINR-r16 | NULL | |
| } | | OPTIONAL, -- Need R |
| codebookConfig-r16 | CodebookConfig-r16 | OPTIONAL -- Need R |
| ]], | | |
| [[ | | |
| cqi-BitsPerSubband-r17 | ENUMERATED {bits4} | OPTIONAL, -- Need R |
| groupBasedBeamReporting-v1710 | SEQUENCE { | |
| nrofReportedGroups-r17 | ENUMERATED {n1, n2, n3, n4} | |
| } | | OPTIONAL, -- Need R |
| codebookConfig-r17 | CodebookConfig-r17 | OPTIONAL, -- Need R |
| sharedCMR-r17 | ENUMERATED {enable} | OPTIONAL, -- Need R |
| csi-ReportMode-r17 | ENUMERATED {mode1, mode2} | OPTIONAL, -- Need R |
| numberOfSingleTRP-CSI-Model-r17 | ENUMERATED {n0, n1, n2} | OPTIONAL, -- Need R |
| reportQuantity-r17 | CHOICE { | |
| cri-RSRP-Index-r17 | NULL, | |
| ssb-Index-RSRP-Index-r17 | NULL, | |
| cri-SINR-Index-r17 | NULL, | |
| ssb-Index-SINR-Index-r17 | NULL | |
| } | | OPTIONAL -- Need R |
| ]], | | |
| [[ | | |
| semiPersistentOnPUSCH-v1720 | SEQUENCE { | |
| reportSlotOffsetList-r17 | SEQUENCE (SIZE (1.. maxNrofUL-Allocations-r16)) OF INTEGER(0..128) | OPTIONAL, -- Need R |
| reportSlotOffsetListDCI-0-2-r17 | SEQUENCE (SIZE (1.. maxNrofUL-Allocations-r16)) OF INTEGER(0..128) | OPTIONAL, -- Need R |
| reportSlotOffsetListDCI-0-1-r17 | SEQUENCE (SIZE (1.. maxNrofUL-Allocations-r16)) OF INTEGER(0..128) | OPTIONAL -- Need R |
| } | | OPTIONAL, -- Need R |
| aperiodic-v1720 | SEQUENCE { | |
| reportSlotOffsetList-r17 | SEQUENCE (SIZE (1.. maxNrofUL-Allocations-r16)) OF INTEGER(0..128) | OPTIONAL, -- Need R |
| reportSlotOffsetListDCI-0-2-r17 | SEQUENCE (SIZE (1.. maxNrofUL-Allocations-r16)) OF INTEGER(0..128) | OPTIONAL, -- Need R |
| reportSlotOffsetListDCI-0-1-r17 | SEQUENCE (SIZE (1.. maxNrofUL-Allocations-r16)) OF INTEGER(0..128) | OPTIONAL -- Need R |
| } | | OPTIONAL -- Need R |
| ]], | | |
| [[ | | |
| codebookConfig-v1730 | CodebookConfig-v1730 | OPTIONAL -- Need R |
| ]], | | |
| [[ | | |
| groupBasedBeamReporting-v1800 | SEQUENCE { | |
| reportingMode-r18 | ENUMERATED {jointULDL, onlyUL} | |
| } | | OPTIONAL, -- Need R |
| reportQuantity-r18 | TDCP-r18 | OPTIONAL, -- Need R |
| codebookConfig-r18 | CodebookConfig-r18 | OPTIONAL, -- Need R |
| csi-ReportSubConfigToAddModList-r18 | SEQUENCE (SIZE (1..maxNrofCSI-ReportSubconfigPerCSI-ReportConfig-r18)) OF CSI-ReportSubConfig- | |
| r18 | | |
| | | OPTIONAL, -- Need N |
| csi-ReportSubConfigToReleaseList-r18 | SEQUENCE (SIZE (1..maxNrofCSI-ReportSubconfigPerCSI-ReportConfig-r18)) OF CSI- | |
| ReportSubConfigId-r18 | | |
| | | OPTIONAL -- Need N |
| ]] | | |
| } | | |
| CSI-ReportPeriodicityAndOffset ::= | CHOICE { | |
| slots4 | INTEGER(0..3), | |
| slots5 | INTEGER(0..4), | |
| slots8 | INTEGER(0..7), | |
| slots10 | INTEGER(0..9), | |
| slots16 | INTEGER(0..15), | |
| slots20 | INTEGER(0..19), | |
| slots40 | INTEGER(0..39), | |
| slots80 | INTEGER(0..79), | |
| slots160 | INTEGER(0..159), | |
| slots320 | INTEGER(0..319) | |
| } | | |
| PortIndexFor8Ranks ::= | CHOICE { | |
| portIndex8 | SEQUENCE{ | |
| rank1-8 | PortIndex8 | OPTIONAL, -- Need R |
| rank2-8 | SEQUENCE(SIZE(2)) OF PortIndex8 | OPTIONAL, -- Need R |
| rank3-8 | SEQUENCE(SIZE(3)) OF PortIndex8 | OPTIONAL, -- Need R |
| rank4-8 | SEQUENCE(SIZE(4)) OF PortIndex8 | OPTIONAL, -- Need R |
| rank5-8 | SEQUENCE(SIZE(5)) OF PortIndex8 | OPTIONAL, -- Need R |
| rank6-8 | SEQUENCE(SIZE(6)) OF PortIndex8 | OPTIONAL, -- Need R |
| rank7-8 | SEQUENCE(SIZE(7)) OF PortIndex8 | OPTIONAL, -- Need R |
| rank8-8 | SEQUENCE(SIZE(8)) OF PortIndex8 | OPTIONAL -- Need R |
| }, | | |
| portIndex4 | SEQUENCE{ | |
| rank1-4 | PortIndex4 | OPTIONAL, -- Need R |
| rank2-4 | SEQUENCE(SIZE(2)) OF PortIndex4 | OPTIONAL, -- Need R |
| rank3-4 | SEQUENCE(SIZE(3)) OF PortIndex4 | OPTIONAL, -- Need R |
| rank4-4 | SEQUENCE(SIZE(4)) OF PortIndex4 | OPTIONAL -- Need R |
| }, | | |
| portIndex2 | SEQUENCE{ | |
| rank1-2 | PortIndex2 | OPTIONAL, -- Need R |
| rank2-2 | SEQUENCE(SIZE(2)) OF PortIndex2 | OPTIONAL -- Need R |
| }, | | |
| portIndex1 | NULL | |
| } | | |
| PortIndex8::= | INTEGER (0..7) | |
| PortIndex4::= | INTEGER (0..3) | |
| PortIndex2::= | INTEGER (0..1) | |
| TDCP-r18 ::= | SEQUENCE { | |
| delayDSetofLengthY-r18 | SEQUENCE (SIZE (1.. maxNrofdelayD-r18)) OF DelayD, | |
| phaseReporting-r18 | ENUMERATED {enable} | OPTIONAL -- Need R |
| } | | |
| DelayD ::= | ENUMERATED { symb4, slot1, slot2, slot3, slot4, slot5, slot6, slot10 } | |
| CSI-ReportSubConfig-r18 ::= | SEQUENCE { | |
| reportSubConfigId-r18 | CSI-ReportSubConfigId-r18, | |
| reportSubConfigParams-r18 | CHOICE { | |
| a1-parameters | SEQUENCE { | |
| codebookSubConfig-r18 | CodebookConfig | OPTIONAL, -- Need R |
| portSubsetIndicator-r18 | CHOICE { | |
| p2 | BIT STRING (SIZE (2)), | |
| p4 | BIT STRING (SIZE (4)), | |
| p8 | BIT STRING (SIZE (8)), | |
| p12 | BIT STRING (SIZE (12)), | |
| p16 | BIT STRING (SIZE (16)), | |
| p24 | BIT STRING (SIZE (24)), | |
| p32 | BIT STRING (SIZE (32)) | |
| } | | OPTIONAL, -- Need R |
| non-PMI-PortIndication-r18 | SEQUENCE (SIZE (1..maxNrofNZP-CSI-RS-ResourcesPerConfig)) OF PortIndexFor8Ranks | |
| | | OPTIONAL -- Need R |
| }, | | |
| a2-parameters | SEQUENCE { | |
| nzp-CSI-RS-ResourceList-r18 | SEQUENCE (SIZE (1..maxNrofNZP-CSI-RS-ResourcesPerSet)) OF NZP-CSI-RS-ResourceIndex-r18 | |
| } | | |
| } | | OPTIONAL, -- Need R |
| powerOffset-r18 | INTEGER(0..23) | OPTIONAL -- Need R |

| } | |
|---|---|
| NZP-CSI-RS-ResourceIndex-r18 ::= | INTEGER (0..maxNrofNZP-CSI-RS-ResourcesPerSet-1-r18) |

CSI-ReportConfig field descriptions

carrier
Indicates in which serving cell the CSI-ResourceConfig indicated below are to be found. If the field is absent, the resources are on the
same serving cell as this report configuration.
codebookConfig
Codebook configuration for Type-1 or Type-2 including codebook subset restriction. Network can only configure one of
codebookConfig, codebookConfig-r16 or codebookConfig-r17 or codebookConfig-r18 in a CSI-ReportConfig. The network includes
codebookConfig-v1730 only if codebookConfig-r17 is configured.
cqi-BitsPerSubband
This field can only be present if cqi-FormatIndicator is set to subbandCQI. If the field is configured with bits4, the UE uses 4-bit sub-
band CQI. If the field is not present and cqi-FormatIndicator is set to subbandCQI, the UE uses 2-bit sub-band differential CQI.
cqi-FormatIndicator
Indicates whether the UE shall report a single (wideband) or multiple (subband) CQI (see TS 38.214 [19], clause 5.2.1.4).
cqi-Table
Which CQI table to use for CQI calculation (see TS 38.214 [19], clause 5.2.2.1). For an (e)RedCap UE, CQI table 2 is only supported if
the UE indicates support of 256QAM for PDSCH.
csi-IM-ResourcesForInterference
CSI IM resources for interference measurement. csi-ResourceConfigId of a CSI-ResourceConfig included in the configuration of the
serving cell indicated with the field “carrier” above. The CSI-ResourceConfig indicated here contains only CSI-IM resources. The bwp-
ID in that CSI-ResourceConfig is the same value as the bwp-Id in the CSI-ResourceConfig indicated by
resourcesForChannelMeasurement.
csi-ReportingBand
Indicates a contiguous or non-contiguous subset of subbands in the bandwith part which CSI shall be reported for. Each bit in the bit-
string represents one subband in order of frequency position in the BWP. The right-most bit in the bit string represents the lowest
subband with the lowest frequency position in the BWP. The choice determines the number of subbands (subbands3 for 3 subbands,
subbands4 for 4 subbands, and so on) (see TS 38.214 [19], clause 5.2.1.4). This field is absent if there are less than 24 PRBs (no subband)
and present otherwise (see TS 38.214 [19], clause 5.2.1.4).
NOTE: In TS 38.212 [17] clause 6.3.1.1.2 and TS 38.214 [19] clause 5.2.1.4, only subbands to be reported are numbered, e.g.
subband #0 is the subband correspoding to the right-most bit set to 1.
csi-ReportMode
Configures the CSI report modes Mode1 or Mode 2 (see TS 38.214 [19], clause 5.2.1.4.2)
csi-ReportSubConfigToAddModList
List of CSI-ReportSubConfiguration(s) in a CSI report configuartion to add or modify. No simultaneous configuration of
portSubsetIndicator and a list of nzp-CSI-RS-resources in a same CSI report sub-configuration. The number of elements in a list is at
least 2.
csi-ReportSubConfigToReleaseList
List of CSI-ReportSubConfiguration(s) in a CSI report configuration to release.
dummy
This field is not used in the specification. If received it shall be ignored by the UE.
groupBasedBeamReporting
Turning on/off group beam based reporting (see TS 38.214 [19], clause 5.2.1.4). If groupBasedBeamReporting (without suffix) is set to
disabled, groupBasedBeamReporting-v1710 and groupBasedBeamReporting-v1800 is absent.
non-PMI-PortIndication
Port indication for RI/CQI calculation. For each CSI-RS resource in the linked ResourceConfig for channel measurement, a port
indication for each rank R, indicating which R ports to use. Applicable only for non-PMI feedback (see TS 38.214 [19], clause
5.2.1.4.2).
The first entry in non-PMI-PortIndication corresponds to the NZP-CSI-RS-Resource indicated by the first entry in nzp-CSI-RS-
Resources in the NZP-CSI-RS-ResourceSet indicated in the first entry of nzp-CSI-RS-ResourceSetList of the CSI-ResourceConfig
whose CSI-ResourceConfigId is indicated in a CSI-MeasID together with the above CSI-ReportConfigId; the second entry in non-PMI-
PortIndication corresponds to the NZP-CSI-RS-Resource indicated by the second entry in nzp-CSI-RS-Resources in the NZP-CSI-RS-
ResourceSet indicated in the first entry of nzp-CSI-RS-ResourceSetList of the same CSI-ResourceConfig, and so on until the NZP-
CSI-RS-Resource indicated by the last entry in nzp-CSI-RS-Resources in the in the NZP-CSI-RS-ResourceSet indicated in the first
entry of nzp-CSI-RS-ResourceSetList of the same CSI-ResourceConfig. Then the next entry correspons to the NZP-CSI-RS-
Resource indicated by the first entry in nzp-CSI-RS-Resources in the NZP-CSI-RS-ResourceSet indicated in the second entry of nzp-
CSI-RS-ResourceSetList of the same CSI-ResourceConfig and so on.
nrofReportedGroups
Number of reported resource groups per CSI-report. Value n1 means one resource group, n2 means 2 resource groups, and so on. If
nrofReportedGroups is configured, the UE ignores groupBasedBeamReporting (without suffix).
nrofReportedRS
The number (N) of measured RS resources to be reported per report setting in a non-group-based report. N <= N_max, where N_max
is either 2 or 4 depending on UE capability.
(see TS 38.214 [19], clause 5.2.1.4) When the field is absent the UE applies the value 1.
numberOfSingleTRP-CSI-Mode1
Configures the number of reported X CSIs when csi-ReportMode is set to ‘Mode 1’ as described in TS 38.214 [19], clause 5.2.1.4.2.
The field is present only if csi-ReportMode configures Mode 1.
nzp-CSI-RS-ResourcesForInterference
NZP CSI RS resources for interference measurement. csi-ResourceConfigId of a CSI-ResourceConfig included in the configuration of
the serving cell indicated with the field “carrier” above. The CSI-ResourceConfig indicated here contains only NZP-CSI-RS resources.
The bwp-Id in that CSI-ResourceConfig is the same value as the bwp-Id in the CSI-ResourceConfig indicated by
resourcesForChannelMeasurement.
p0alpha
Index of the p0-alpha set determining the power control for this CSI report transmission (see TS 38.214 [19], clause 6.2.1.2).
pdsch-BundleSizeForCSI
PRB bundling size to assume for CQI calculation when reportQuantity is CRI/RI/i1/CQI. If the field is absent, the UE assumes that no
PRB bundling is applied (see TS 38.214 [19], clause 5.2.1.4.2).
pmi-FormatIndicator
Indicates whether the UE shall report a single (wideband) or multiple (subband) PMI. (see TS 38.214 [19], clause 5.2.1.4).
pucch-CSI-ResourceList
Indicates which PUCCH resource to use for reporting on PUCCH.
reportConfigType
Time domain behavior of reporting configuration.
reportFreqConfiguration
Reporting configuration in the frequency domain. (see TS 38.214 [19], clause 5.2.1.4).
reportQuantity
The CSI related quantites to report. see TS 38.214 [19], clause 5.2.1. If the field reportQuantity-r16, reportQuantity-r17 or
reportQuantity-r18 is present, UE shall ignore reportQuantity (without suffix). Network does not configure reportQuantity-r17 or
reportQuantity-r18 together with reportQuantity-r16.
reportingMode
Configures the UE with reporting mode for group based reporting.(see TS 38.214 [19] clause 5.2.1.4).
reportSlotConfig
Periodicity and slot offset (see TS 38.214 [19], clause 5.2.1.4). If the field reportSlotConfig-v1530 is present, the UE shall ignore the
value provided in reportSlotConfig (without suffix).
reportSlotOffsetList, reportSlotOffsetListDCI-0-1, reportSlotOffsetListDCI-0-2
Timing offset Y for semi persistent reporting using PUSCH. This field lists the allowed offset values. This list must have the same
number of entries as the pusch-TimeDomainAllocationList is PUSCH-Config. A particular value is indicated in DCI. The network
indicates in the DCI field of the UL grant, which of the configured report slot offsets the UE shall apply. The DCI value 0 correponds to
the first report slot offset in the list, the DCI value 1 corresponds to te second report slot offset in the list, and so on. The first report is
transmitted in slot n + Y, second report in n + Y + P, where P is the configured periodicity.
Timing offset Y for aperiodic reporting using PUSCH. This field lists the allowed offset values. This list must have the same number of
entries as the pusch-TimeDomainAllocationList in PUSCH-Config. A particular value is indicated in DCI. The network indicates in the
DCI field of the UL grant, which of the configured report slot offsets the UE shall apply. The DCI value 0 corresponds to the first report
slot offset in this list, the DCI value 1 corresponds to the second report slot offset in the list, and so on (see TS 38.214 [19], clause
6.1.2.1).
The field reportSlotOffsetListDCI-0-1 applies to DCI format 0_1 and the field reportSlotOffsetListDCI-0-2 applies to DCI format 0_2
(see TS 38.214 [19], clause 6.1.2.1).
The field reportSlotOffsetList-r17, reportSlotOffsetListDCI-0-1-r17 and reportSlotOffsetListDCI-0-2-r17 are only applicable for SCS
480 kHz and 960 kHz and if they are configured, the UE shall ignore the fields reportSlotOffsetList (without suffix),
reportSlotOffsetListDCI-0-1 (without suffix) and reportSlotOffsetListDCI-0-2 (without suffix) for SCS 480 kHz and 960 kHz.
resourceForChannelMeasurement
Resources for channel measurement. csi-ResourceConfigId of a CSI-ResourceConfig included in the configuration of the serving cell
indicated with the field “carrier” above. The CSI-ResourceConfig indicated here contains only NZP-CSI-RS resources and/or SSB
resources. This CSI-ReportConfig is associated with the DL BWP indicated by bwp-Id in that CSI-ResourceConfig.
sharedCMR
Enables sharing of channel measurement resources between different CSI measurement hypotheses when (1) csi-ReportMode is set
to ‘Mode1’ and numberOfSingleTRP-CSI-Mode1 is set to 1 or 2; or (2) csi-ReportMode is set to ‘Mode2’ (see TS 38.214 [19], clause
5.2.1.4.2).
subbandSize
Indicates one out of two possible BWP-dependent values for the subband size as indicated in TS 38.214 [19], table 5.2.1.4-2. If csi-
ReportingBand is absent, the UE shall ignore this field.
timeRestrictionForChannelMeasurements
Time domain measurement restriction for the channel (signal) measurements (see TS 38.214 [19], clause 5.2.1.1).
timeRestrictionForInterferenceMeasurements
Time domain measurement restriction for interference measurements (see TS 38214 [19], clause 5.2.1.1).

### ******************************END OF QUOTATION [3]******************************

In [4] RAN2 #128 Chair Notes, the following is provided:

### ******************************START OF QUOTATION [4]******************************

### 8.1.2.2 LCM for UE-Sided Model for Beam Management Use Case

Including functionality identification, additional conditions and further reporting of applicable functionalities. Contributions should focus on issues not dependent on RAN1 (i.e. on questions we sent to RAN1) and issues we haven't yet discussed (e.g. necessary signalling/protocols to configure the UE for training, etc)
. . .

### Data Collection and Training

### Details on Data Collection Configuration

R2-2409716 Discussion on LCM for UE-sided model for BM use case CATT discussion Rel-19 NR_AIML_air-Core
   Proposal 9: For BM use case for UE-side model, data collection related configuration(s) (e.g., measurement resources configuration) and associated ID can be included in training data collection configuration.
      Nokia wants to avoid having a limitation that a measurement is only associated with one ID.
      It can be associated to multiple ID. Apple thinks that it can provide multiple associated ID.
      Nokia doesn't understand why the associated ID Is needed. Oppo explains that the UE needs to know for applicability purposes.
   Noted
   For BM use case for UE-side model, data collection related configuration(s) (e.g., measurement resources configuration) and associated ID(s) can be included in training data collection configuration.

### Data Collection Configuration and Initiation

R2-2409870 Further Discussion on LCM for UE-side Model MediaTek Inc. discussion
   Proposal 3: RAN2 consider the following two alternatives for data collection configuration and initiation for UE-side model training:
      Alternative 1-UE request over the air interface: The UE sends a request for data collection configuration and initiation. The network then provides the data collection configuration and initiates the data collection procedure based on the UE's request.
      Alternative 2-Server request over network interfaces: The server for data collection for UE-side model training server sends the request and coordinates with the network on the data collection policy. The network then provides the data collection configuration and initiates the data collection procedure towards the UE based on the server's coordination.
   Noted
R2-2409546 LCM for UE-sided model for Beam Management use case OPPO discussion Rel-19 NR_AIML_air-Core
   Proposal 7: Do not consider data collection initiation based on UE request in R19, i.e. it's up to NW to decide when to initiate data collection for training purpose in R19.
   Noted
   Discussion
      LG doesn't understand why alternative 2 is needed. Samsung thinks it is reasonable to look at both options, but if we want to minimize alt. 1 is preferable and Alt. 2 would depend SA2 discussion.
      Lenovo thinks that alternative 1 is preferable as we are discussing UE sided model.
      Ericsson agrees with Mediatek, Samsung, Lenovo.
      Vivo thinks alternative 1 baseline but we shouldn't exclude alternative 2.
      Qualcomm thinks that alternative 1 needs to be adapted as the OTT server is not aware of UE conditions like power etc.
      Tmobile thinks that this is dependent on architecture. Samsung and qualcomm explain that this is a UE.
   Noted
   For data collection configuration UE-side model training, the UE can send a request for data collection. FFS what the request contains. The network can provide the data collection configuration.

### Network Control of Data Collection

R2-2410626 On LCM for UE-sided model for Beam Management ZTE Corporation discussion Rel-19 NR_AIML_air-Core
   Proposal 7: RAN 2 to consider following methods for network control of the initiation and configuration for data collection:
      The network can decide when to start/stop the data collection.
      The network can configure whether UE is allowed to initiate request for data collection.
      The network can decide whether to accept UE's request for data collection.
      Samsung would like to ensure that there should be a way that the UE tell the network that it can't do it even if it receives the configuration. Qualcomm thinks that the UE will ultimately chose if it can do the data collection based on available resources and power. There is no need for additional confirmation. Nokia thinks this is not acceptable that the UE ignores. Verizon thinks that it would be useful to get an indication from the UE when it can't collect data based on received configuration.
   The following methods for network control of the initiation and configuration for data collection:
      The network can decide when to start/stop the data collection and send configuration.
      The network can configure whether UE is allowed to initiate request for data collection.
      The network can decide whether to accept UE's request for data collection.

Agreements

| | |
|---|---|
| 1. | When a functionality configured by the network to be reported via UAI, becomes from non- |
| | applicable to applicable, the UE can reports it to the network. FFS detailed design |
| 2. | When a functionality becomes non-applicable the UE doesn't autonomously deactivate. NW |
| | is expected to deactivate active functionality when it receives report from UE that it is non- |
| | applicable. |
| 3. | FFS whether the UE reports explicitly “non-applicable” functionality when there is a change |
| | of applicability. Verify this aligns with RAN1 configuration design |
| 4. | Applicable functionality reporting at handover is supported with the same RRC procedure |
| | that will be specified within a cell, as a baseline, i.e. the NW-side additional conditions and/or |
| | the inference configuration related to the target gNB are transmitted by the target gNB as |
| | part of the HO command, and the UE in response transmits the applicability report (either in |
| | RRCReconfigurationComplete or in UAI) to the target gNB after completing the handover. |
| 5. | Source cell UAI (as is) can be sent from source cell to target cell using existing signaling. |
| | No further optimizations will be considered in RAN2 related to UAI. |
| 6. | For BM use case for UE-side model, data collection related configuration(s) (e.g., |
| | measurement resources configuration) and associated ID(s) can be included in training data |
| | collection configuration. |
| 7. | For data collection configuration UE-side model training, the UE can send a request for data |
| | collection. FFS what the request contains. |
| 8. | The network can provide the data collection configuration (at any point in time), with or |
| | without UE request. |
| 9. | The following methods for network control of the initiation and configuration for data |
| | collection: |
| | The network can decide when to start/stop the data collection and send configuration. |
| | The network can configure whether UE is allowed to initiate request for data collection. |
| 10. | FFS whether an indication from UE to network is needed when UE can't perform data |
| | collection based on received configuration |

### ******************************END OF QUOTATION [4]******************************

Artificial Intelligence and Machine Learning (AI/ML) is introduced in 5G-Advanced to enhance the network/User Equipment (UE).

For the challenging scenarios of high frequencies, rapidly changing conditions, and narrow coverages of beams, AI/ML models are introduced in 5G-Advanced to pave the way into 6G, with expectations of AI/ML models exceeding traditional methods in terms of performance.

For the air interface, 3rd Generation Partnership Project (3GPP) Working Group 1 (WG1) identified the following use cases to enhance: Channel State Information (CSI) feedback enhancement, beam management, and positioning accuracy enhancement. Beam management is one of the most important use cases. The current beam management procedure consists of at least one or more of the following steps: (1) beam sweeping, (2) UE measurement of beams, (3) UE reporting of beams. For example, the Next Generation Node B (gNB) first transmits multiple beams of different directions and angles. The UE then measures all the beams that are transmitted and determines the beams with the best measurement results (e.g., Reference Signal Received Power (RSRP) or Signal-to-Interference-plus-Noise Ratio (SINR)). The best results are reported through the CSI-Reporting framework. The UE may be configured and/or activated to perform periodic, semi-persistent, or aperiodic reporting of the beam results. The configuration and measurement for beams can be large. With AI/ML assistance, the UE may spatially predict beams to reduce the number of measurements performed. The UE may also temporally predict future beams for the challenging problem of fast changing conditions to make beam pair establishment more feasible in the Frequency Range 2 (FR2) scenarios.

For mobility, several aspects of the Layer 3 (L3) measurement framework also have enhancement potential. The current L3 handover mechanism relies on a tailored measurement configuration which utilizes measurement objects, reports configurations and measurement identities to configure the frequencies and cells for the UE to measure. The UE first measures the configured frequencies and cells, then reports the measurement results to the Network (NW), when the measurement results fulfill the report triggering conditions. The NW may reconfigure the UE to perform handover according to the triggered event type and the measurement results. The mechanism works fine but is still limited to a reactive method. With the lower coverage of higher frequency, handover may occur more frequently and thus a more proactive method may be pursued. Currently, for AI/ML mobility enhancements, Radio Resource Management (RRM) measurement prediction, Radio Link Failure (RLF)/Handover Failure (HoF) prediction and measurement event prediction are studied. For RRM measurement prediction, the UE may predict measurement results of future time instances or measurement results of another cell based on historical measurements and include the predicted measurements in a measurement report. For RLF/HOF prediction, the UE may predict the chances of RLF/HOF happening within a time window (or period) before RLF/HoF actually happens. For measurement event prediction, the UE may predict the chances of a measurement event (e.g., Event A3) happening (or triggering a report, fulfilling the entering and/or leaving condition) within a time window (or period), and send a measurement report to the NW. With the assistance of AI/ML models, the UE may proactively react to potential radio problems and enhance the handover performance. Redundant measurements may also be reduced to save resources (e.g., measurement gaps, UE power).

In order to perform inference for an AI/ML functionality, configuration, and/or feature, the UE (or UE-side server) may have to first train (or receive/obtain) a UE-side AI/ML model. The UE may also want to (re) train (or finetune) an AI/ML model in order to improve the performance of the AI/ML model although the AI/ML is already trained. For training UE-side AI/ML models, the UE may collect data and use the collected data to train UE-side AI/ML models. The collected data may include the input and/or output (e.g., ground truth) for training the UE-side AI/ML models. For example, the collected data may include Reference Signal RS resources (e.g., Synchronization Signal Block (SSB)/Channel State Information Reference Signal (CSI-RS)) to measure. To perform data collection, the UE may be configured data collection configuration(s) by the NW (for training UE-side AI/ML models).

In [4] RAN2 #128 ChairNotes, RAN2 agreed that the UE can send a request (to the NW) for data collection. The request may include a preference to the NW. The preference may be for whether to start/stop data collection. The preference may be for whether the UE requests for one or more data collection configurations. The preference may be for UE providing one or more preferred data collection configurations. The NW may start/stop data collection (at UE-side), provide one or more data collection configurations, and/or provide one or more data collection configurations preferred by the UE in response.

However, it is unclear of the conditions for the UE to request (e.g., whether the UE can request, whether the UE can request under a condition, whether the UE can request for a (specific) preference, whether the UE can request for a (specific) preference under a condition). It is also unclear of what is included in the request (e.g., how to start/stop data collection, how to indicate the preferred configuration(s)).

To at least solve the issue(s) described above, at least some method(s) described below could be used or considered. At least one or more of the methods (or examples, concepts) described below may be used or considered. At least one or more of the methods (or examples, concepts) may be combined.

With the following and herein, a “legacy configuration” may be (replaced by) a “configuration before release 19”, “configuration without AI/ML enhancements”, and/or “configuration without release 19 (AI/ML) enhancements”. An “inference configuration” may be (replaced by) a “configuration for inference” or “configuration related to AI/ML” or “(inference) configuration” or “configuration comprising AssociatedId or being configured with AssociatedId” or “configuration comprising set A and set B”. A “functionality” may be (replaced by) an “inference configuration” and/or “configuration”. A “configuration” may be (replaced by) a “legacy configuration (other than a configuration introduced for AI/ML enhancements)” and/or “inference configuration”. The configuration(s) may be for CSI reporting.

With the following and herein, a “set of parameters” may be a “set of inference related parameters”. The set(s) of parameters may be for CSI reporting based on AI/ML.

With the following and herein, indication(s) (or flag(s)/parameter(s)) may be (or include) (the existence of) an Information Element (IE), sequence, list, number, integer, enum, enumerated, choice, bit string, or Boolean value. For example, to indicate a first purpose/type, the indication could (or may) be set to a first value/IE or to be present. For example, to indicate a second purpose/type, the indication could (or may) be set to a second value/IE or to be not present.

With the following and herein, “measurement result” may be (replaced by) “L1-RSRP”, “RS resource” may be (replaced by) “SSB/CSI-RS”, “measurement configuration” may be (replaced by) “CSI measurement configuration”.

With the following and herein, “data collection” may be (replaced by) “UE-side data collection”, “data collection for training UE-side AI/ML models”.

With the following and herein, “data collection configuration(s)” may be (replaced by) “configuration(s) associated with data collection”.

With the following and herein, “feature”, “feature group”, “functionality” may be (replaced by) “AI/ML for beam management”, “AI/ML for CSI reporting”, “AI/ML for CSI prediction”, “AI/ML for CSI compression”, “AI/ML for air interface”, “AI/ML for mobility”, “AI/ML for RRM prediction”, “AI/ML for measurement event prediction”, “AI/ML for RLF prediction”, “AI/ML for HOF prediction”, “AI/ML for any (legacy/existing) feature/feature group/functionality”.

The NW may provide a first configuration to the UE. The first configuration may include (or be associated with) an Identity/Identifier (ID). The ID may indicate (or identify) the first configuration. The UE may receive the first configuration. The first configuration may indicate (or include) one or more RS resources for data collection. The first configuration may include at least a first set of RS resources and a second set of RS resources. The first and second set of RS resources may be indicated by ID(s) (e.g., CSI-Resource ConfigId, Non-Zero Power (NZP)-CSI-RS-ResourceSetId, CSI-SSB-ResourceSetId, CSI-Interference Measurement (IM)-ResourceSetId, etc.). The first configuration may include at least one AssociatedId. The UE may assume similar properties of a Downlink (DL) Transmitter (Tx) beam or beam set/list associated with the same AssociatedId value. The AssociatedId value is unique within a Public Land Mobile Network (PLMN), i.e., it can only be associated with one same/similar beam deployment within the same PLMN. The first configuration may be associated with AI/ML. The first configuration may be associated with (UE-side) data collection.

Preferably in certain embodiments, the first configuration (and/or the parameters in the first configuration) may be associated with a (UE-side) data collection configuration. The first configuration may be for indicating preferred data collection configuration to the NW. The UE may indicate preferred data collection configuration to the NW based on the first configuration.

For example, a first IE may be used to indicate one or more RS resources for data collection.

For example, the first IE may be a set of RS resources.

For example, the first IE may include (or associate) 1 set of RS resources (e.g., the first set of RS resources or the second set of RS resources).

For example, the first IE may include (or associate) 2 sets (or 1 pair of sets) of RS resources (e.g., the first set of RS resources and the second set of RS resources).

For example, the first IE may include (or associate) more than 2 sets of RS resources (e.g., including at least the first set of RS resources and the second set of RS resources).

For example, the first IE may include (or associate) more than 1 pair of sets of RS resources (e.g., including at least the first set of RS resources and the second set of RS resources).

For example, each set of RS resources may be identified by (or include, associated with) a first (type of) ID (e.g., CSI-ResourceConfigId, NZP-CSI-RS-ResourceSetId, CSI-SSB-ResourceSetId, CSI-IM-ResourceSetId, etc.).

For example, each pair of sets of RS resources may be identified by (or include, associated with) a second (type of) ID.

For example, the first configuration may be the first IE.

For example, the first configuration may include (or associate) 1 first IE.

For example, the first configuration may include (or associate) 2 (or 1 pair of) first IEs.

For example, the first configuration may include (or associate) more than 2 first IEs.

For example, the first configuration may include (or associate) more than 1 pair of first IEs.

For example, each IE may be identified by (or include, associated with) a third (type of) ID.

For example, each pair of IEs may be identified by (or include, associated with) a fourth (type of) ID.

For example, the first configuration may be identified by (or include, associated with) a fifth (type of) ID (e.g., CSI-ReportConfigId).

For example, the first configuration may not be a (measurement) configuration for (legacy/normal) measurement, inference, monitoring, training, and/or UE-side data collection.

Alternatively and/or additionally in certain embodiments, the UE may perform measurement and/or collect data (e.g., measurement result(s)) based on the first configuration. The first configuration may indicate the UE not to report the measurement result(s) to the NW. The UE may perform measurements based on the configured RS resources in the first configuration (e.g., in response to/after receiving the first configuration). The UE may not report the measurement result(s) through Physical Uplink Control Channel (PUCCH), Physical Uplink Shared Channel (PUSCH), Medium Access Control (MAC) Control Element (CE), and/or Radio Resource Control (RRC) message. For example, when the UE receives the first configuration, the UE may not report the measurement result(s) to the NW based on the first configuration. For example, when configuring the first set of RS resources and the second set of RS resources, the UE may perform measurement on both the first set of RS resources and the second set of RS resources.

Alternatively and/or additionally in certain embodiments, the first configuration may be for one AI/ML based feature/functionality/configuration. For example, the first configuration may include (or be) a configuration for a first intention (e.g., for collecting a first set of RS resources and/or a second set of RS resources).

The NW may provide a second configuration to the UE. The second configuration may include (or be associated with) an ID. The ID may indicate (or identify) the second configuration. The UE may receive the second configuration. The second configuration may be a CSI-ReportConfig.

The second configuration may be associated with AI/ML. Alternatively and/or preferably in certain embodiments, the second configuration may be not associated with AI/ML. The second configuration may include RS resources for the UE to measure. The second configuration may include RS resources for the UE to predict. The second configuration may include one or more AssociatedIds. The second configuration may include multiple CSI-ReportConfigIds. The second configuration may include report quantity (e.g., reportQuantity) that is not none, CSI-RS Resource Indicator (CRI), Channel Quality Indicator (CQI), Precoding Matrix Indicator (PMI), Rank Indicator (RI), Layer Indicator (LI), RSRP, and/or SINR. Alternatively and/or preferably in certain embodiments, the second configuration may include report quantity (e.g., reportQuantity) that is none, CRI, CQI, PMI, RI, LI, RSRP, and/or SINR. The second configuration may include the number of RS resources (e.g., nrofReportedRS) for the UE to report.

For example, the second configuration may be (or include) RS resource(s), measurement configuration(s) (e.g., CSI-MeasConfig, CSI-ReportConfig, CSI-ResourceConfig, NZP-CSI-RS-ResourceSet, CSI-SSB-ResourceSet, CSI-IM-ResourceSet, etc.), performance monitoring configuration(s), data collection configuration(s), and/or configuration(s) related to inference (e.g., inference configuration, partial configuration for inference, one set or multiple sets of inference related parameters).

Preferably in certain embodiments, the second configuration may be associated with (UE-side) data collection. The second configuration may be (indicated to be) training (or data collection for UE-side AI/ML models) type, and/or for training (or data collection for UE-side AI/ML models) purposes. The second configuration may include a report quantity (e.g., reportQuantity) that is none. The second configuration may indicate (or include) one or more RS resources for data collection. The second configuration may include at least a first set of RS resources and a second set of RS resources. The first and second set of RS resources may be indicated by ID(s) (e.g., CSI-ResourceConfigId, NZP-CSI-RS-ResourceSetId, CSI-SSB-ResourceSetId, CSI-IM-ResourceSetId, etc.). The second configuration may include at least one AssociatedId. The UE may perform measurement and/or collect data (e.g., measurement result(s)) based on the second configuration. The second configuration may indicate the UE not to report the measurement result(s) to the NW. The UE may perform measurements based on the configured RS resources in the second configuration (e.g., in response to/after receiving the second configuration). The UE may not report the measurement result(s) through PUCCH, PUSCH, MAC CE, and/or RRC message. For example, when the UE received the second configuration, the UE may not report the measurement result(s) to the NW based on the second configuration. For example, when configured with the first set of RS resources and the second set of RS resources, the UE may perform measurements on both the first set of RS resources and the second set of RS resources.

Alternatively and/or additionally in certain embodiments, the second configuration may not be associated with data collection. The second configuration may be (indicated to be) not data collection type, and/or not for data collection purposes.

Alternatively and/or additionally in certain embodiments, the second configuration may be associated with a (legacy) measurement. The second configuration may be (indicated to be) a (normal) CSI-ReportConfig without specifically indicated purposes. The second configuration may include a report quantity (e.g., reportQuantity) that is none, CRI, CQI, PMI, RI, LI, RSRP, and/or SINR. The UE may perform measurements and/or report the measurement result(s), based on the configured RS resources in the second configuration (e.g., in response to/after receiving the second configuration). The UE may report the measurement result(s) through PUCCH and/or PUSCH.

Alternatively and/or additionally in certain embodiments, the second configuration may be associated with inference. The second configuration may be an (indicated to be) inference type, and/or for inference purposes. The second configuration may include a report quantity (e.g., reportQuantity) that is not none, CRI, CQI, PMI, RI, LI, RSRP, and/or SINR. The second configuration may include one or more AssociatedIds. The second configuration may include at least a third set of RS resources and a fourth set of RS resources. When the second configuration is for inference purposes, the second configuration may measure the third set of RS resources and not the fourth set of RS resources. The first set of RS resources may be associated with the third set of RS resources. The second set of RS resources may be associated with the fourth set of RS resources.

Alternatively and/or additionally in certain embodiments in certain embodiments, the second configuration may be associated with monitoring. The second configuration may be (indicated to be) monitoring type, and/or for monitoring purposes. The second configuration may include multiple CSI-ReportConfigIds.

The UE may send a first request providing the UE's preference (or request) on data collection. The request may include, e.g., preferred configuration, start/stop. The preference (or request) may be for whether to start/stop (or activate/deactivate) data collection. The preference (or request) may be for whether the UE requests one or more data collection configurations. The UE may include (additional/assistance) information to assist/inform the NW (e.g., for the decision of which configuration to provide). The preference (or request) may be for a UE providing one or more preferred data collection configurations. The preferred data collection configurations may be indicated based on RS resource(s), measurement configuration(s) (e.g., CSI-MeasConfig, CSI-ReportConfig, CSI-ResourceConfig, NZP-CSI-RS-ResourceSet, CSI-SSB-ResourceSet, CSI-IM-ResourceSet, etc.), performance monitoring configuration(s), data collection configuration(s), and/or configuration(s) related to inference (e.g., inference configuration, partial configuration for inference, one set or multiple sets of inference related parameters). The NW may start/stop (or activate/deactivate) data collection (at UE-side), provide one or more data collection configurations, and/or provide one or more data collection configurations preferred (or requested) by the UE (in response to receiving the request). The NW may provide the first configuration and/or second configuration, and/or start/stop (or activate/deactivate) data collection based on the received content in the request. The first configuration and/or second configuration may be based on the content in the request.

The first request may be an RRC message. The first request may be a UE Assistance Information (UAI) message. The first request may be a response/complete message (e.g., RRCReconfigurationComplete, RRCSetupComplete, RRCReestablishmentComplete, RRCResumeComplete).

The first request may include (at least) a first content. The first content may include one or more indications to (or for) one or more configurations (or RS resources) (e.g., measurement configuration, AI/ML related configuration, data collection configuration). The first content may be for indicating one or more preferred data collection configurations. The first content may indicate the first configuration and/or the second configuration. The first content may indicate the preferred data collection configurations based on the first and/or the second configuration. The first content may indicate the preferred data collection configurations based on RS resource(s), measurement configuration(s) (e.g., CSI-MeasConfig, CSI-ReportConfig, CSI-ResourceConfig, NZP-CSI-RS-ResourceSet, CSI-SSB-ResourceSet, CSI-IM-ResourceSet, etc.), performance monitoring configuration(s), data collection configuration(s), and/or configuration(s) related to inference (e.g., inference configuration, partial configuration for inference, one set or multiple sets of inference related parameters).

For example, the UE may indicate one or more data collection configurations (or RS resources) (e.g., the first configuration and/or second configuration) in the first request (e.g., the first content), for indicating the desired data collection configuration. For example, the UE may indicate one or more configurations (or RS resources) (e.g., the first configuration and/or the second configuration) in the first request, for indicating the desired data collection configuration to be the one that may have association to the indicated configuration in the first request.

The NW may provide configuration(s) (e.g., the first configuration and/or the second configuration) for (or associated with) the indicated configuration (e.g., the first configuration and/or the second configuration) (, in response to receiving the first request). The first configuration and/or the second configuration may be for (or associated with) the indicated configuration.

The first request may include (at least) a second content. The second content may not include one or more indications to (or for) one or more configurations (or RS resources) (e.g., measurement configuration, AI/ML related configuration, data collection configuration). The second content may be for requesting one or more data collection configurations (e.g., any data collection configuration the NW could provide). The second content may not indicate the first configuration and/or the second configuration. The second content may not indicate the preferred data collection configurations based on the first and/or the second configuration. The second content may not indicate the preferred data collection configurations based on RS resource(s), measurement configuration(s) (e.g., CSI-MeasConfig, CSI-ReportConfig, CSI-ResourceConfig, NZP-CSI-RS-ResourceSet, CSI-SSB-ResourceSet, CSI-IM-ResourceSet, etc.), performance monitoring configurations, data collection configuration(s) and/or configuration(s) related to inference (e.g., inference configuration, partial configuration for inference, one set or multiple sets of inference related parameters). The second content may indicate one or more features/feature groups/functionalities. The second content may include (additional/assistance) information to assist/inform the NW (e.g., for the decision of which configuration to provide). For example, the (additional/assistance) information may include the number of RS resources, number of RS resources in a first set of RS resources, number of RS resources in a second set of RS resources, periodicity and/or offset, periodicity and/or offset for a first set of RS resources, periodicity and/or offset for a second set of RS resources, duration, beam pattern, pattern of a first set of RS resources, pattern of a second set of RS resources, relation between a first set of RS resources and a second set of RS resources (e.g., overlapping pattern), AssociatedId.

The NW may provide the configuration(s) (e.g., the first configuration and/or the second configuration) (, in response to receiving the first request). The configuration(s) (e.g., the first configuration and/or the second configuration) may be for (or associated with) one or more (or the indicated) features/feature groups/functionalities.

The first request may include (at least) a third content. The third content may include one or more indications to (or for) one or more configurations (e.g., measurement configuration, AI/ML related configuration, data collection configuration). The third content may be for the start (or activation) of (data collection) configurations (e.g., the first configuration and/or the second configuration). The third content may indicate the first configuration and/or the second configuration. The third content may indicate (data collection) configurations based on RS resource(s), measurement configuration(s) (e.g., CSI-MeasConfig, CSI-ReportConfig, CSI-ResourceConfig, NZP-CSI-RS-ResourceSet, CSI-SSB-ResourceSet, CSI-IM-ResourceSet, etc.), performance monitoring configuration(s), data collection configuration(s), and/or configuration(s) related to inference (e.g., inference configuration, partial configuration for inference, one set or multiple sets of inference related parameters). The third content may indicate one or more features/feature groups/functionalities. The third content may indicate the start (or activation) of data collection for all data collection configurations, all data collection configurations for the indicated features/feature groups/functionalities, one configuration, one pair of sets of RS resources, and/or one set of RS resources.

The NW may start (or activate) the configuration (or data collection, measurement) for (or associated with) the indicated configuration (or RS resources) (e.g., the first configuration and/or the second configuration) (, in response to receiving the first request). The NW may start (or activate) the configuration(s) (or data collection, measurement) for (or associated with) the indicated features/feature groups/functionalities (e.g., the first configuration and/or the second configuration) (, in response to receiving the first request). The NW may start (or activate) the data collection and/or measurement of all data collection configurations (e.g., the first configuration and/or the second configuration) (, in response to receiving the first request).

The first request may include (at least) a fourth content. The fourth content may include one or more indications to (or for) one or more configurations (e.g., measurement configuration, AI/ML related configuration, data collection configuration). The fourth content may be for the stopping (or deactivation) of (data collection) configurations (e.g., the first configuration and/or the second configuration). The fourth content may indicate the first configuration and/or the second configuration. The fourth content may indicate (data collection) configurations based on RS resource(s), measurement configuration(s) (e.g., CSI-MeasConfig, CSI-ReportConfig, CSI-ResourceConfig, NZP-CSI-RS-ResourceSet, CSI-SSB-ResourceSet, CSI-IM-ResourceSet, etc.), performance monitoring configuration(s), data collection configuration(s), and/or configuration(s) related to inference (e.g., inference configuration, partial configuration for inference, one set or multiple sets of inference related parameters). The fourth content may indicate one or more features/feature groups/functionalities. The fourth content may indicate the stop (or deactivation) of data collection for all data collection configurations, all data collection configurations for the indicated features/feature groups/functionalities, one configuration, one pair of sets of RS resources, and/or one set of RS resources.

The NW may stop (or deactivate) the configuration (or data collection, measurement) for (or associated with) the indicated configuration (or RS resources) (e.g., the first configuration and/or the second configuration) (, in response to receiving the first request). The NW may stop (or deactivate) the configuration(s) (or data collection, measurement) for (or associated with) the indicated features/feature groups/functionalities (e.g., the first configuration and/or the second configuration) (, in response to receiving the first request). The NW may stop (or deactivate) the data collection and/or measurement of all data collection configurations (e.g., the first configuration and/or the second configuration) (, in response to receiving the first request).

One (type of) content (e.g., the first, second, third, and/or fourth content) may include an indication to differentiate from other (type of) contents (e.g., the first, second, third, and/or fourth content). For example, by using a different IE and/or message. For example, by including an indication indicate the IE and/or message is for the purposes of a (type of) content (e.g., the first, second, third, and/or fourth content).

The request may be sent and/or the content may be determined based on one or more conditions (e.g., whether there is a data collection configuration).
Case A: The UE may send the first request when the UE does not receive (or before the UE receives) the first configuration and/or the second configuration. The UE may send the first request when the UE does not have at least (one of) the first configuration and/or the second configuration. The UE may send the first request when the UE does not have at least one measurement configuration (e.g., CSI-MeasConfig, CSI-ReportConfig, CSI-ResourceConfig, NZP-CSI-RS-ResourceSet, CSI-SSB-ResourceSet, CSI-IM-ResourceSet, etc.), performance monitoring configuration, UE-side data collection configuration, NW-side data collection configuration, and/or configuration related to inference (e.g., inference configuration, partial configuration for inference, one set or multiple sets of inference related parameters).
Case B: The UE may send the first request when the UE receives (or after the UE receives) the first configuration and/or the second configuration. The UE may send the first request when the UE has at least (one of) the first configuration and/or the second configuration. The UE may send the first request when the UE has at least one measurement configuration (e.g., CSI-MeasConfig, CSI-ReportConfig, CSI-ResourceConfig, NZP-CSI-RS-ResourceSet, CSI-SSB-ResourceSet, CSI-IM-ResourceSet, etc.), performance monitoring configuration, UE-side data collection configuration, NW-side data collection configuration, and/or configuration related to inference (e.g., inference configuration, partial configuration for inference, one set or multiple sets of inference related parameters).

For Case A, the UE may (send a) request for:
The start of data collection (e.g., the third content) (e.g., when a configuration is started (automatically) after/upon reception); and/or
One or more data collection configurations (e.g., the second content).

For Case A, the UE may not (send a) request for:
The start of data collection (e.g., the third content);
The stop of data collection (e.g., the fourth content); and/or
One or more preferred data collection configurations (e.g., the first content).

For Case B, the UE may (send a) request for:
The start of data collection (, when there is at least one data collection procedure is not started or the corresponding configuration is not started) (e.g., the third content);
The stop of data collection (, when there is at least one data collection procedure started or the corresponding configuration is (already) started) (e.g., the fourth content);
One or more data collection configurations (e.g., the second content); and/or
One or more preferred data collection configurations (e.g., the first content).

For Case B, the UE may not (send a) request for:
The start of data collection (, when there is no data collection procedure is not started or the corresponding configuration is (already) started) (e.g., the third content);
The stop of data collection (, when there is at least one data collection procedure started or the corresponding configuration is not started) (e.g., the fourth content); and/or
One or more data collection configurations (e.g., the second content).

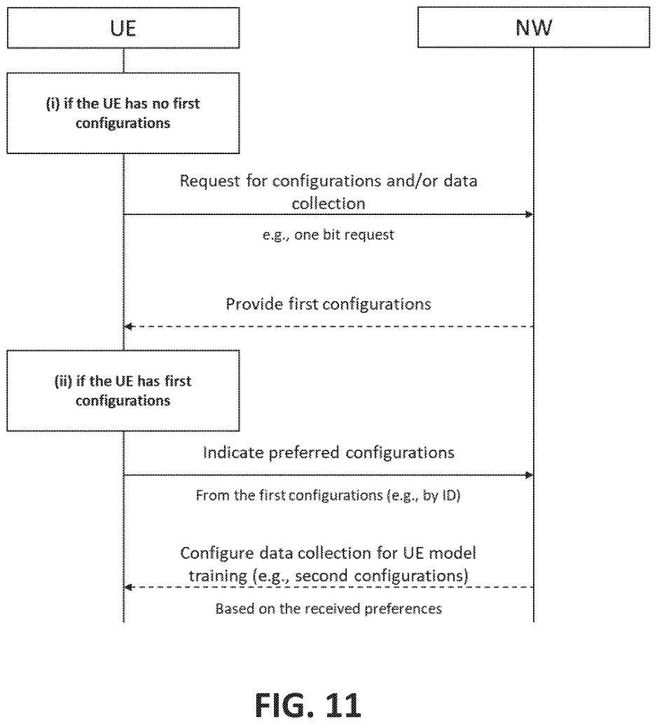

FIG. 11 is a diagram showing an example for requesting data collection and indicating UE preferences. What content may be included in the first request may be based on the received configuration(s) (e.g., the first configuration and/or the second configuration).

For example, when (or after) the UE (has) received the first configuration, the UE may include one or more preferred data collection configurations (e.g., the first content), one or more data collection configurations (e.g., the second content), the start of data collection (e.g., the third content), and/or the stop of data collection (e.g., the fourth content) (based on the first configuration) in the first request.

For example, when (or after) the UE (has) received the second configuration, the UE may include one or more preferred data collection configurations (e.g., the first content), and/or the start of data collection (e.g., the third content) (e.g., when a configuration is started (automatically) after/upon reception) (, based on the second configuration) in the first request.

For example, when (or after) the UE (has) received the first configuration and the second configuration, the UE may include the content based on the first configuration and the content based on the second configuration in the first request. For example, the first request may include content(s) for different purposes and/or configurations. For example, when the UE received multiple configurations, wherein the configurations may include configurations for a first purpose (e.g., the first configuration) and configurations for a second purpose (e.g., the second configuration), the first request may include content(s) for one or more of the received configurations (, based on each configuration respectively).

In one example, in a request for the first content (e.g., the first request), the UE may include an indication for differentiating the (type of) request content (e.g., indicating the request includes the first content) and/or one or more IDs in the request. The included ID(s) may be the first, second, third, fourth, and/or fifth (type of) ID. The first, second, third, fourth, and/or fifth (type of) ID may be used to indicate a configuration (or RS resources) (e.g., the first configuration and/or the second configuration).

For example, when (or in response to) the NW receives a request for the first content (e.g., the first request), the NW may provide data collection configuration(s) and/or RS resources (e.g., the first configuration and/or the second configuration) to the UE based on the received ID(s).

In one example, in a request for the second content (e.g., the first request), the UE may include an indication for differentiating the (type of) request content (e.g., indicating the request includes the second content) and/or one or more fields in the request. The included field(s) may indicate one or more features/feature groups/functionalities. The included field(s) may indicate no specific (type of) data collection configuration is requested. For example, when there is no ID or field included in the request (e.g., the first request), the UE may indicate (or be indicating) all data collection configurations (or RS resources), and/or any data collection configuration (or RS resources) the NW could provide (or has configured).

For example, when (or in response to) the NW receives a request for the second content (e.g., the first request), wherein the request does not include one or more fields indicating one or more features/feature groups/functionalities, or the request indicates no specific (type of) data collection configuration is requested, the NW may provide data collection configuration(s) and/or RS resources (e.g., the first configuration) to the UE.

For example, when (or in response to) the NW receives a request for the second content (e.g., the first request), wherein the request includes one or more fields indicating one or more features/feature groups/functionalities, the NW may provide data collection configuration(s) and/or RS resources (of one or more features/feature groups/functionalities) (e.g., the first configuration) to the UE based on the received field(s) indicating one or more features/feature groups/functionalities.

In one example, in a request for the third content (e.g., the first request), the UE may include an indication for differentiating the (type of) request content (e.g., indicating the request includes the third content), one or more IDs, and/or one or more fields in the request. The included ID(s) may be the first, second, third, fourth, and/or fifth (type of) ID. The first, second, third, fourth, and/or fifth (type of) ID may be used to indicate a configuration (or RS resources) (e.g., the first configuration and/or the second configuration). The included field(s) may indicate one or more features/feature groups/functionalities. The included field(s) may indicate no specific (type of) data collection configuration is requested. When there is no ID or field included in the request (e.g., the first request), the UE may indicate (or be indicating) all data collection configurations (or RS resources) and/or any data collection configuration (or RS resources) the NW could provide (or has configured).

For example, when (or in response to) the NW receives a request for the third content (e.g., the first request), wherein the request includes one or more IDs indicating one or more configurations (or RS resources), the NW may start (or activate) data collection (configuration(s) and/or RS resources) (e.g., the first configuration and/or the second configuration) based on the received ID(s).

For example, when (or in response to) the NW receives a request for the third content (e.g., the first request), wherein the request includes one or more fields indicating one or more features/feature groups/functionalities, the NW may start (or activate) data collection (for all configuration(s) and/or RS resources of one or more features/feature groups/functionalities) (e.g., the first configuration and/or the second configuration) based on the received field(s) indicating one or more features/feature groups/functionalities.

For example, when (or in response to) the NW receives a request for the third content (e.g., the first request), wherein the request does not include one or more fields indicating one or more features/feature groups/functionalities, or the request indicates no specific (type of) data collection configuration is requested, the NW may start (or activate) data collection and/or RS resources (for all configuration(s)) (e.g., the first configuration and/or the second configuration).

In one example, in a request for the fourth content (e.g., the first request), the UE may include an indication for differentiating the (type of) request content (e.g., indicating the request includes the fourth content), one or more IDs, and/or one or more fields in the request. The included ID(s) may be the first, second, third, fourth, and/or fifth (type of) ID. The first, second, third, fourth, and/or fifth (type of) ID may be used to indicate a configuration (or RS resources) (e.g., the first configuration and/or the second configuration). The included field(s) may indicate one or more features/feature groups/functionalities. The included field(s) may indicate no specific (type of) data collection configuration is requested. When there is no ID or field included in the request (e.g., the first request), the UE may indicate (or be indicating) all data collection configurations (or RS resources) and/or any data collection configuration (or RS resources) the NW could provide (or has configured).

For example, when (or in response to) the NW receives a request for the fourth content (e.g., the first request), wherein the request includes one or more IDs indicating one or more configurations (or RS resources), the NW may stop (or deactivate) data collection (configuration(s) and/or RS resources) (e.g., the first configuration and/or the second configuration) based on the received ID(s).

For example, when (or in response to) the NW receives a request for the fourth content (e.g., the first request), wherein the request includes one or more fields indicating one or more features/feature groups/functionalities, the NW may stop (or deactivate) data collection (for all configuration(s) and/or RS resources of one or more features/feature groups/functionalities) (e.g., the first configuration and/or the second configuration) based on the received field(s) indicating one or more features/feature groups/functionalities.

For example, when (or in response to) the NW receives a request for the fourth content (e.g., the first request), wherein the request does not include one or more fields indicating one or more features/feature groups/functionalities, or the request indicates no specific (type of) data collection configuration is requested, the NW may stop (or deactivate) data collection and/or RS resources (for all configuration(s)) (e.g., the first configuration and/or the second configuration).

For example, to start (or activate) one or more data collection configurations (or RS resources) (e.g., the first configuration and/or the second configuration), the NW may provide one or more data collection configurations (or RS resources) (e.g., the first configuration and/or the second configuration), or provide a signaling (e.g., RRC/MAC CE/Downlink Control Information (DCI)) to start (or activate) one or more data collection configurations (or RS resources) (e.g., the first configuration and/or the second configuration).

For example, to stop (or deactivate) one or more data collection configurations (or RS resources) (e.g., the first configuration and/or the second configuration), the NW may release (or remove) one or more data collection configurations (or RS resources) (e.g., the first configuration and/or the second configuration), or provide a signaling (e.g., RRC/MAC CE/DCI) to stop (or deactivate) one or more data collection configurations (or RS resources) (e.g., the first configuration and/or the second configuration).

For the methods, alternatives, concepts, examples, and embodiments detailed above and herein, the following aspects and embodiments are possible.

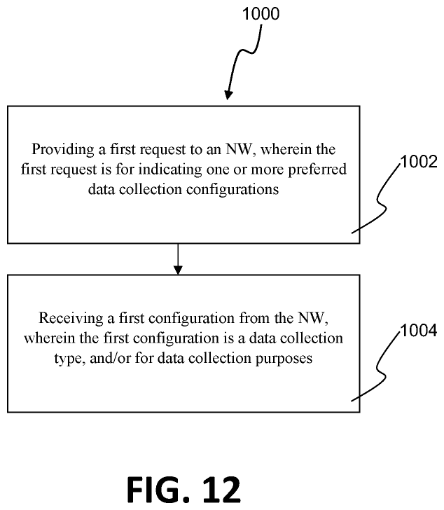

Referring to FIG. 12, with this and other concepts, systems, and methods of the present invention, a method 1000 for a UE in a wireless communication system comprises providing a first request to an NW, wherein the first request is for indicating one or more preferred data collection configurations (step 1002), and receiving a first configuration from the NW, wherein the first configuration is a data collection type, and/or for data collection purposes (step 1004).

In various embodiments, the first request includes one or more IDs for indicating one or more configurations.

In various embodiments, the configurations indicated by the one or more IDs in the first request can be at least one of measurement configuration, performance monitoring configuration, data collection configuration, or configuration related to inference.

In various embodiments, the first configuration is based on the first request.

Referring back to FIGS. 3 and 4, in one or more embodiments from the perspective of a UE in a wireless communication system, the device 300 includes a program code 312 stored in memory 310 of the transmitter. The CPU 308 could execute program code 312 to: (i) provide a first request to an NW, wherein the first request is for indicating one or more preferred data collection configurations; and (ii) receive a first configuration from the NW, wherein the first configuration is a data collection type, and/or for data collection purposes. Moreover, the CPU 308 can execute the program code 312 to perform all of the described actions, steps, and methods described above, below, or otherwise herein.

Referring back to FIGS. 3 and 4, in one or more embodiments from the perspective of an NW in a wireless communication system, the device 300 includes a program code 312 stored in memory 310 of the transmitter. The CPU 308 could execute program code 312 to: (i) receive a first request from a UE, wherein the first request is for indicating one or more preferred data collection configurations; and (ii) send a first configuration to the UE, wherein the first configuration is a data collection type, and/or for data collection purposes. Moreover, the CPU 308 can execute the program code 312 to perform all of the described actions, steps, and methods described above, below, or otherwise herein.

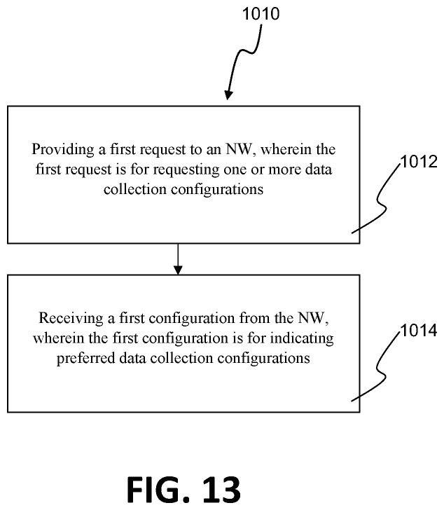

Referring to FIG. 13, with this and other concepts, systems, and methods of the present invention, a method 1010 for a UE in a wireless communication system comprises providing a first request to an NW, wherein the first request is for requesting one or more data collection configurations (step 1012), and receiving a first configuration from the NW, wherein the first configuration is for indicating preferred data collection configurations (step 1014).

In various embodiments, the one or more data collection configurations requested in the first request can be any data collection configuration the NW could provide.

In various embodiments, the first request includes one or more fields for indicating one or more features/feature groups/functionalities or no specific (type of) data collection configuration is requested.

In various embodiments, the first request includes (additional/assistance) information.

In various embodiments, the first configuration is based on the first request.

Referring back to FIGS. 3 and 4, in one or more embodiments from the perspective of a UE in a wireless communication system, the device 300 includes a program code 312 stored in memory 310 of the transmitter. The CPU 308 could execute program code 312 to: (i) provide a first request to an NW, wherein the first request is for requesting one or more data collection configurations; and (ii) receive a first configuration from the NW, wherein the first configuration is for indicating preferred data collection configurations. Moreover, the CPU 308 can execute the program code 312 to perform all of the described actions, steps, and methods described above, below, or otherwise herein.

Referring back to FIGS. 3 and 4, in one or more embodiments from the perspective of an NW in a wireless communication system, the device 300 includes a program code 312 stored in memory 310 of the transmitter. The CPU 308 could execute program code 312 to: (i) receive a first request from a UE, wherein the first request is for requesting one or more data collection configurations; and (ii) send a first configuration to the UE, wherein the first configuration is for indicating preferred data collection configurations. Moreover, the CPU 308 can execute the program code 312 to perform all of the described actions, steps, and methods described above, below, or otherwise herein.

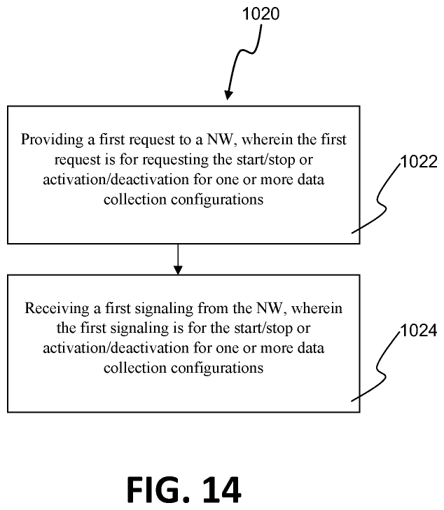

Referring to FIG. 14, with this and other concepts, systems, and methods of the present invention, a method 1020 for a UE in a wireless communication system comprises providing a first request to an NW, wherein the first request is for requesting the start/stop or activation/deactivation for one or more data collection configurations (step 1022), and receiving a first signaling from the NW, wherein the first signaling is for the start/stop or activation/deactivation for one or more data collection configurations (step 1024).

Referring back to FIGS. 3 and 4, in one or more embodiments from the perspective of a UE in a wireless communication system, the device 300 includes a program code 312 stored in memory 310 of the transmitter. The CPU 308 could execute program code 312 to: (i) provide a first request to an NW, wherein the first request is for requesting the start/stop or activation/deactivation for one or more data collection configurations; and (ii) receive a first signaling from the NW, wherein the first signaling is for the start/stop or activation/deactivation for one or more data collection configurations. Moreover, the CPU 308 can execute the program code 312 to perform all of the described actions, steps, and methods described above, below, or otherwise herein.

Referring back to FIGS. 3 and 4, in one or more embodiments from the perspective of an NW in a wireless communication system, the device 300 includes a program code 312 stored in memory 310 of the transmitter. The CPU 308 could execute program code 312 to: (i) receive a first request from a UE, wherein the first request is for requesting the start/stop or activation/deactivation for one or more data collection configurations; and (ii) send a first signaling to the UE, wherein the first signaling is for the start/stop or activation/deactivation for one or more data collection configurations. Moreover, the CPU 308 can execute the program code 312 to perform all of the described actions, steps, and methods described above, below, or otherwise herein.

In various embodiments, the first request includes one or more IDs for indicating one or more configurations.

In various embodiments, the first request includes one or more fields for indicating one or more features/feature groups/functionalities or no specific (type of) data collection configuration is requested.

In various embodiments, which data collection configurations are indicated by the first signaling to start/stop or activate/deactivate is based on the first request.

In various embodiments, the first signaling starts/stops or activates/deactivates all configured data collection configurations.

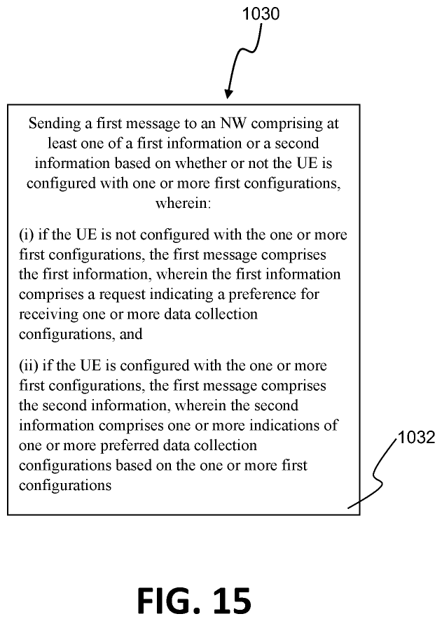

Referring to FIG. 15, with this and other concepts, systems, and methods of the present invention, a method 1030 for a UE in a wireless communication system comprises sending a first message to an NW comprising at least one of a first information or a second information based on whether or not the UE is configured with one or more first configurations, wherein: (i) if the UE is not configured with the one or more first configurations, the first message comprises the first information, wherein the first information comprises a request indicating a preference for receiving one or more data collection configurations, and (ii) if the UE is configured with the one or more first configurations, the first message comprises the second information, wherein the second information comprises one or more indications of one or more preferred data collection configurations based on the one or more first configurations (step 1032).

In various embodiments, the second information comprises one or more IDs, wherein at least one of the one or more IDs correspond to one of the one or more first configurations, and/or the second information comprising one or more IDs indicates a preference of being configured with at least one data collection configuration or at least one Reference Signal (RS) resource associated with the corresponding one or more first configurations.

In various embodiments, the method further comprises receiving the one or more first configurations in response to or after sending the first message comprising and/or indicating the first information to the NW.

In various embodiments, the method further comprises receiving one or more second configurations in response to or after sending the first message comprising and/or indicating the second information to the NW.

In various embodiments, the method further comprises performing one or more measurements and/or data collection based on the one or more second configurations, and sending a third message to the NW comprising a third information, wherein the third information comprises one or more indications for stopping the one or more data collection configurations based on the one or more second configurations, and/or wherein the third information comprises one or more IDs corresponding to the one or more second configurations, and/or the third information comprising one or more IDs indicates a preference of stopping the corresponding one or more second configurations.

In various embodiments, the one or more second configurations comprise at least a configuration for data collection or UE-side data collection, wherein the configuration is a measurement configuration or CSI-ReportConfig, comprising at least one of: (i) one or more RS resources for data collection or UE-side data collection, and (ii) one or more indications for indicating the UE not to report one or more measurement results.

In various embodiments, the method further comprises at least one of: based on the one or more first configurations, reporting one or more preferred data collection configurations, based on the one or more second configurations, performing one or more measurements, and based on the one or more second configurations, not reporting one or more measurements.

In various embodiments, the one or more first configurations comprise at least a configuration for indicating the one or more preferred data collection configurations, wherein the configuration comprises one or more RS resources for data collection or UE-side data collection.

In various embodiments, the first information indicates at least one of: (i) one or more features, feature groups, and/or functionalities, and (ii) a preference for receiving the one or more data collection configurations, and/or a specific configuration or type of configuration is not indicated by the first information (e.g., the first information does not comprise ID associated with the specific configuration or type of configuration).

In various embodiments, the one or more first configurations are for a feature, feature group, and/or functionality.

Referring back to FIGS. 3 and 4, in one or more embodiments from the perspective of a UE in a wireless communication system, the device 300 includes a program code 312 stored in memory 310 of the transmitter. The CPU 308 could execute program code 312 to: (i) send a first message to an NW comprising at least one of a first information or a second information based on whether or not the UE is configured with one or more first configurations, wherein: (a) if the UE is not configured with the one or more first configurations, the first message comprises the first information, wherein the first information comprises a request indicating a preference for receiving one or more data collection configurations, and (b) if the UE is configured with the one or more first configurations, the first message comprises the second information, wherein the second information comprises one or more indications of one or more preferred data collection configurations based on the one or more first configurations. Moreover, the CPU 308 can execute the program code 312 to perform all of the described actions, steps, and methods described above, below, or otherwise herein.

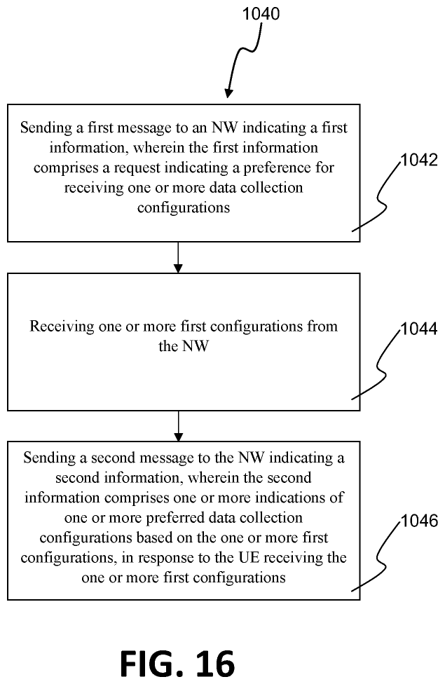

Referring to FIG. 16, with this and other concepts, systems, and methods of the present invention, a method 1040 for a UE in a wireless communication system comprises sending a first message to an NW indicating a first information, wherein the first information comprises a request indicating a preference for receiving one or more data collection configurations (step 1042), receiving one or more first configurations from the NW (step 1044), and sending a second message to the NW indicating a second information, wherein the second information comprises one or more indications of one or more preferred data collection configurations based on the one or more first configurations, in response to the UE receiving the one or more first configurations (step 1046).

In various embodiments, the method further comprises receiving one or more second configurations from the NW, performing one or more measurements and data collection based on the one or more second configurations, and sending a third message to the NW indicating a third information, wherein the third information comprises one or more indications for stopping the one or more data collection configurations based on the one or more second configurations.

In various embodiments, the third information comprises one or more IDs, wherein at least one of the one or more IDs corresponds to one of the one or more second configurations, and/or the third information comprising one or more IDs indicates a preference of stopping the corresponding one or more second configurations.

In various embodiments, the first message is sent if the UE is not configured with the one or more first configurations, or the first message is not sent if the UE is configured with or has the one or more first configurations.

In various embodiments, the second information comprises one or more IDs, wherein at least one of the one or more IDs corresponds to one of the one or more first configurations, and/or the second information comprising one or more IDs indicates a preference of being configured with at least one data collection configuration or at least one RS resource associated with the corresponding one or more first configurations.

Referring back to FIGS. 3 and 4, in one or more embodiments from the perspective of a UE in a wireless communication system, the device 300 includes a program code 312 stored in memory 310 of the transmitter. The CPU 308 could execute program code 312 to: (i) send a first message to an NW indicating a first information, wherein the first information comprises a request indicating a preference for receiving one or more data collection configurations; (ii) receive one or more first configurations from the NW; and (iii) send a second message to the NW indicating a second information, wherein the second information comprises one or more indications of one or more preferred data collection configurations based on the one or more first configurations, in response to the UE receiving the one or more first configurations. Moreover, the CPU 308 can execute the program code 312 to perform all of the described actions, steps, and methods described above, below, or otherwise herein.

Any combination of the above or herein concepts or teachings can be jointly combined, in whole or in part, or formed to a new embodiment. The disclosed details and embodiments can be used to solve at least (but not limited to) the issues mentioned above and herein.

It is noted that any of the methods, alternatives, steps, examples, and embodiments proposed herein may be applied independently, individually, and/or with multiple methods, alternatives, steps, examples, and embodiments combined together.

Various aspects of the disclosure have been described above. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. As an example of some of the above concepts, in some aspects, concurrent channels may be established based on pulse repetition frequencies. In some aspects, concurrent channels may be established based on pulse position or offsets. In some aspects, concurrent channels may be established based on time hopping sequences. In some aspects, concurrent channels may be established based on pulse repetition frequencies, pulse positions or offsets, and time hopping sequences.

Those of ordinary skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of ordinary skill in the art would further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

In addition, the various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects, any suitable computer-program product may comprise a computer-readable medium comprising codes relating to one or more of the aspects of the disclosure. In some aspects, a computer program product may comprise packaging materials.

While the invention has been described in connection with various aspects and examples, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

What is claimed is:

1. A method of a User Equipment (UE), comprising:
sending a first message to a Network (NW) comprising at least one of a first information or a second information based on whether or not the UE is configured with one or more first configurations, wherein:
(i) if the UE is not configured with the one or more first configurations, the first message comprises the first information, wherein the first information comprises a request indicating a preference for receiving one or more data collection configurations; and
(ii) if the UE is configured with the one or more first configurations, the first message comprises the second information, wherein the second information comprises one or more indications of one or more preferred data collection configurations based on the one or more first configurations.

2. The method of claim 1, wherein the second information comprises one or more Identities (IDs), wherein at least one of the one or more IDs corresponds to one of the one or more first configurations, and/or the second information comprising one or more IDs indicates a preference of being configured with at least one data collection configuration or at least one Reference Signal (RS) resource associated with the corresponding one or more first configurations.

3. The method of claim 1, further comprising receiving the one or more first configurations in response to or after sending the first message comprising the first information to the NW.

4. The method of claim 1, further comprising receiving one or more second configurations in response to or after sending the first message comprising the second information to the NW.

5. The method of claim 4, further comprising:
performing one or more measurements and/or data collection based on the one or more second configurations; and
sending a third message to the NW comprising a third information, wherein the third information comprises one or more indications for stopping the one or more data collection configurations based on the one or more second configurations, and/or wherein the third information comprises one or more IDs corresponding to the one or more second configurations, and/or the third information comprising one or more IDs indicates a preference of stopping the corresponding one or more second configurations.

6. The method of claim 4, wherein the one or more second configurations comprise at least a configuration for data collection or UE-side data collection, wherein the configuration is a measurement configuration or Channel State Information (CSI)-ReportConfig, comprising at least one of: (i) one or more RS resources for data collection or UE-side data collection; and (ii) one or more indications for indicating the UE not to report one or more measurement results.

7. The method of claim 4, further comprising at least one of:
based on the one or more first configurations, reporting one or more preferred data collection configurations;
based on the one or more second configurations, performing one or more measurements; and
based on the one or more second configurations, not reporting one or more measurements.

8. The method of claim 1, wherein the one or more first configurations comprise at least a configuration for indicating the one or more preferred data collection configurations, wherein the configuration comprises one or more RS resources for data collection or UE-side data collection.

9. The method of claim 1, wherein the first information indicates at least one of: (i) one or more features, feature groups, and/or functionalities; and (ii) a preference for receiving the one or more data collection configurations, and/or wherein a specific configuration or type of configuration is not indicated by the first information.

10. The method of claim 1, wherein the one or more first configurations are for a feature, feature group, and/or functionality.

11. A method of a User Equipment (UE), comprising:
sending a first message to a Network (NW) indicating a first information, wherein the first information comprises a request indicating a preference for receiving one or more data collection configurations;
receiving one or more first configurations from the NW; and
sending a second message to the NW indicating a second information, wherein the second information comprises one or more indications of one or more preferred data collection configurations based on the one or more first configurations, in response to the UE receiving the one or more first configurations.

12. The method of claim 11, further comprising:
receiving one or more second configurations from the NW;
performing one or more measurements and data collection based on the one or more second configurations; and
sending a third message to the NW indicating a third information, wherein the third information comprises one or more indications for stopping the one or more data collection configurations based on the one or more second configurations.

13. The method of claim 12, wherein the third information comprises one or more Identities (IDs), wherein at least one of the one or more IDs corresponds to one of the one or more second configurations, and/or the third information comprising one or more IDs indicates a preference of stopping the corresponding one or more second configurations.

14. The method of claim 11, wherein the first message is sent if the UE is not configured with the one or more first configurations, or the first message is not sent if the UE is configured with or has the one or more first configurations.

15. The method of claim 11 wherein the second information comprises one or more IDs, wherein at least one of the one or more IDs corresponds to one of the one or more first configurations, and/or the second information comprising one or more IDs indicates a preference of being configured with at least one data collection configuration or at least one Reference Signal (RS) resource associated with the corresponding one or more first configurations.

16. A User Equipment (UE), comprising:
a memory; and
a processor operatively coupled with the memory, wherein the processor is configured to execute a program code to:
send a first message to a Network (NW) comprising at least one of a first information or a second information based on whether or not the UE is configured with one or more first configurations, wherein:
(i) if the UE is not configured with the one or more first configurations, the first message comprises the first information, wherein the first information comprises a request indicating a preference for receiving one or more data collection configurations; and
(ii) if the UE is configured with the one or more first configurations, the first message comprises the second information, wherein the second information comprises one or more indications of one or more preferred data collection configurations based on the one or more first configurations.

17. The UE of claim 16, wherein the second information comprises one or more Identities (IDs), wherein at least one of the one or more IDs corresponds to one of the one or more first configurations, and/or the second information comprising one or more IDs indicates a preference of being configured with at least one data collection configuration or at least one Reference Signal (RS) resource associated with the corresponding one or more first configurations.

18. The UE of claim 16, wherein the processor is further configured to execute the program code to receive the one or more first configurations in response to or after sending the first message comprising the first information to the NW.

19. The UE of claim 16, wherein the processor is further configured to execute the program code to receive one or more second configurations in response to or after sending the first message comprising the second information to the NW.

20. The UE of claim 16, wherein the processor is further configured to execute the program code to:
perform one or more measurements and/or data collection based on the one or more second configurations; and
send a third message to the NW comprising a third information, wherein the third information comprises one or more indications for stopping the one or more data collection configurations based on the one or more second configurations, and/or wherein the third information comprises one or more IDs corresponding to the one or more second configurations, and/or the third information comprising one or more IDs indicates a preference of stopping the corresponding one or more second configurations.
